(19) United States
(12) Patent Application Publication
(10) Pub. No.: US 2016/0264686 A1
(43) Pub. Date: Sep. 15, 2016

(54) POLYMER PRODUCTION METHOD, POLYMER PRODUCT, PARTICLES, FILM, MOLDED ARTICLE, AND FIBERS

(71) Applicants: Taichi NEMOTO, Shizuoka (JP); Yoko ARAI, Shizuoka (JP); Satoshi IZUMI, Shizuoka (JP); Shigehiro HIRANO, Shizuoka (JP); Takayuki SHIMIZU, Kanagawa (JP); Chiaki TAKANA, Shizuoka (JP)

(72) Inventors: Taichi NEMOTO, Shizuoka (JP); Yoko ARAI, Shizuoka (JP); Satoshi IZUMI, Shizuoka (JP); Shigehiro HIRANO, Shizuoka (JP); Takayuki SHIMIZU, Kanagawa (JP); Chiaki TAKANA, Shizuoka (JP)

(21) Appl. No.: 15/033,783

(22) PCT Filed: Nov. 18, 2014
(86) PCT No.: PCT/JP2014/080998

§ 371 Date: May 2, 2016

(30) Foreign Application Priority Data
Nov. 18, 2013 (JP) 2013-238149
Feb. 28, 2014 (JP) 2014-039375

(51) Int. Cl. C08F 2/12; C08F 12/08; C08F 14/14; C08F 20/34; C08F 18/08; C08F 20/56; C08F 20/10; C08F 20/44

(52) U.S. Cl. CPC C08F 2/12; C08F 20/10; C08F 12/08; C08F 20/44; C08F 20/34; C08F 18/08; C08F 20/56; C08F 14/14; C08F 2400/00; C08F 2438/03

(57) ABSTRACT

A method for producing a polymer, which contains: bringing a monomer containing a vinyl bond into contact with a compressive fluid and melting or dissolving the monomer containing a vinyl bond, followed by carrying out addition polymerization of the monomer containing a vinyl bond in the presence of an initiator.

### TECHNICAL FIELD

The present invention relates to an invention where a monomer containing a vinyl bond is polymerized through addition polymerization.

### BACKGROUND ART

Radical polymerization is a polymerization method where radicals are generated by decomposition using an initiator to carry out addition polymerization of a monomer containing a vinyl bond, and is widely used industrially. The radical polymerization however has a disadvantage that a molecular weight distribution of an obtained polymer product becomes broad. The radical polymerization may not be suitable for use of a polymer product, which requires a narrow molecular weight distribution, as in a case where a block copolymer is produced.

As for a polymerization method capable of solving the disadvantage of radical polymerization, living radical polymerization has been industrially used. An active site is maintained at a terminal of a polymer in living radical polymerization, and therefore a polymer product having a narrow molecular weight distribution tends to be attained. As for methods of living radical polymerization, mainly three methods have been known. Specifically, there are a method using nitroxyl radical (nitroxide mediated radical polymerization (NMP), see PTL 1), atom-transfer radical-polymerization (ATRP, see PTL 2 and PTL 3), and reversible addition fragmentation chain transfer (RAFT) polymerization (see PTL 4). In any of these methods, however, a solvent is used in polymerization, and therefore a step for removing the solvent is required.

As for a method for performing addition polymerization of a monomer containing a vinyl bond without using a solvent, bulk polymerization has been known. When bulk polymerization of a monomer containing a vinyl bond is performed, a large quantity of heat of the reaction is generated. Therefore, there is a case where a polymerization reaction is controlled, for example, by carrying out the polymerization reaction at temperature lower than a melting point or softening point of a polymer to be generated. For example, PTL 5 discloses a method for obtaining a polymer having the number average molecular weight of 1,490 with the conversion ratio of 64% by performing bulk polymerization of chloromethylene styrene at 110° C.

### CITATION LIST

### Patent Literature

PTL 1: Japanese Patent Application Laid-Open (JP-A) No. 60-89452
PTL 2: Japanese Translation of PCT International Application (JP-A) No. 10-509475
PTL 3: JP-A No. 2010-254815
PTL 4: International Publication No. WO 98/01478
PTL 5: JP-A No. 2009-7582

### SUMMARY OF INVENTION

### Technical Problem

In the case where a monomer containing a vinyl bond is polymerized at low temperature without using an organic solvent in the aforementioned manner, however, a viscosity of a reaction product increases as the reaction progresses, and therefore there is a problem that it is difficult to progress the polymerization reaction.

### Solution to Problem

The means for solving the aforementioned problems are as follows:

The method for producing a polymer according to the present invention, containing:

bringing a monomer containing a vinyl bond into contact with a compressive fluid and melting or dissolving the monomer containing a vinyl bond, followed by carrying out addition polymerization of the monomer containing a vinyl bond in the presence of an initiator.

### Advantageous Effects of Invention

The present invention exhibits an effect that a polymerization reaction easily progresses, even in a case where a monomer containing a vinyl bond is polymerized at low temperature, such as the temperature equal to or lower than a melting point or softening point of a polymer to be generated, without using an organic solvent.

### BRIEF DESCRIPTION OF DRAWINGS

FIG. 1 is a phase diagram illustrating states of a substance with respect to temperature and pressure.

FIG. 2 is a phase diagram for defining the range of a compressive fluid in the present embodiment.

FIG. 3 is a system diagram illustrating one example of a polymerizing step.

FIG. 4 is a system diagram illustrating one example of a serial polymerizing step.

### DESCRIPTION OF EMBODIMENTS

An embodiment of the present invention is specifically explained hereinafter. The method for producing a polymer according to the present embodiment contains bringing a living polymerizable monomer containing a vinyl bond into contact with a compressive fluid and melting or dissolving the monomer containing a vinyl bond, followed by carrying out addition polymerization of the monomer containing a vinyl group in the presence of an initiator. The monomer containing a vinyl bond, which is capable of living polymerization, is merely referred to as a monomer, and the addition polymerization is merely referred as polymerization, hereinafter.

As a result of the studies diligently conducted by the present inventor, it has been found out that, by bringing a compressive fluid, which does not have a chemical interaction, such as a salt, and a complex, for example, with a catalyst or initiator for use, into contact with an addition polymerizable monomer containing a vinyl group, which can be polymerized through living polymerization, or a polymer product composed of the addition polymerizable monomer, a viscosity of the mixture thereof is reduced. As a result, a reaction product is turned into a melted state at reaction temperature equal to or lower than a melting point of the polymer, and therefore the reaction uniformly progresses at the temperature equal to or lower than the melting point, and the polymer is also easily taken out after the reaction. Note that, the method for producing a polymer according to the present embodiment is suitably used for production of a polymer, a viscosity of which is reduced with a compressive fluid. According to the production method of the present embodiment, moreover, the reaction temperature can be set low without using an organic solvent, and heat of the reaction can be easily controlled. By setting the reaction temperature low, moreover, a depolymerization reaction is inhibited, and an amount of monomer residues in the polymer product can be reduced to a level that a removal operation thereof is not necessary.

### Raw Materials

First, a monomer containing a vinyl bond, which is used as a raw material in the aforementioned production method, and a component for use, such as a catalyst are explained. Note that, in the present embodiment, the term “raw materials” means materials that will be constitutional components of a polymer. The raw materials contain a monomer, and may further contain appropriately selected optional components, such as an initiator, and additives, according to the necessity.

### Monomer

Examples of a monomer usable in the production method of the present embodiment include a typical monomer containing a vinyl bond usable for living radical polymerization. Examples of the monomer usable for living radical polymerization contain various monomers each containing a vinyl bond, which can be carried out living radical polymerization by a method known in the art. Examples of the monomer usable for living radical polymerization include a mono-substituted ethylene, such as polystyrene, and 1,1-di-substituted ethylene, such as polymethacrylate, through it depends on a type, position, or number of a substituent directly bonding to a double bond. As examples of the monomer, there are a styrene-based monomer (e.g., a styrene derivative), an acryl-based monomer (e.g., acrylate, methacrylate, acrylic acid, and methacrylic acid), an acryl amide-based monomer (e.g., acrylonitrile, and acryl amide), a diene-based monomer (e.g., chloroprene), vinyl acetate, and methyl vinyl ketone, but the monomer is not limited those listed above. Examples of the styrene derivative include styrene, and 4-methyl styrene. Examples of the acrylate include methyl acrylate. Examples of the methacrylate include dimethyl amino ethyl methacrylate, and methyl methacrylate. Polymerization of these monomers can be performed with one type of the monomer. Alternatively, a block copolymer, graft copolymer, or random copolymer, each containing two or more polymer segments can be attained as a polymer product by combining two or more types of monomers depending on a method for adding monomers. However, polymerization of the monomer is not limited. As for a polymer product having two or more polymer segments, a block copolymer (block polymer) having a plurality of polymer segments in combination is preferable in view of sufficiently exhibiting an effect obtainable by the production method of the present embodiment.

In the present embodiment, a block polymer is a linear copolymer to which pluralities of homopolymer chains are bonded as blocks. A typical example of the block polymer is a A-B diblock polymer having a structure where an A block chain having a repeating unit A and a B block chain having a repeating unit B are bonded to each other at a terminal thereof, i.e., -(AA . . . AA)-(BB . . . BB)-. A block polymer where 3 or more polymer chains are bonded may be used. In case of a triblock polymer, a structure thereof may be A-B-A, B-A-B, or A-B-C. Moreover, a star block polymer where one or pluralities of block chains are radially extended from the center thereof can be used. A block having 4 or more block chains, such as (A-B)n type, and (A-B-A)n type, may be used.

Moreover, the copolymer having two or more polymer segments include a copolymer having a multibranched structure, such as a graft polymer. The graft polymer has a structure where a block chain serving as a side chain is hanged from another polymer principle chain. In the graft polymer, a plurality type of polymers can be hanged as side chains. Moreover, a combination of a block polymer and a graft polymer where C block chain is hanged from a block polymer, such as A-B block polymer, A-B-A block polymer, and B-A-B block polymer, may be used. The block polymer is preferably used over the graft polymer because a polymer having a narrow molecular weight distribution tends to be attained, and a composition rate thereof can be easily controlled. A block polymer is explained more in the descriptions below, but the descriptions for the block polymer are also applied to the graft polymer.

### Initiator (Polymerization Initiator)

As for an applicable polymerization initiator in the production method of the present embodiment, a compound containing a group typically known as an initiator group for living radical polymerization is suitably used. An initiator suitably used for each living radical polymerization method, i.e., atom-transfer radical-polymerization (ATRP), reversible addition fragmentation chain transfer (RAFT) polymerization, and a method using nitroxyl radical (nitroxide mediated radical polymerization (NMP)), but an initiator for use or a polymerization method is not limited to those explained below. Note that, the polymerization method is not particularly limited, but among the aforementioned polymerization methods, the atom-transfer radical-polymerization (ATRP) is preferable in view of a degree of general purpose of a polymerization initiator, a variety of applicable monomers, and polymerization temperature.

### ATRP

First, a compound containing a halogenated alkyl group or a halogenated sulfonyl group is typically used in ATRP. The compound containing a halogenated alkyl group or a halogenated sulfonyl group, which is suitably as an initiator, is not particularly limited, and examples thereof include ethyl 2-bromoisobutyrate, the following bifunctional initiator, the following trifunctional initiator, the following tetrafunctional initiator, and the following hexafunctional initiator.

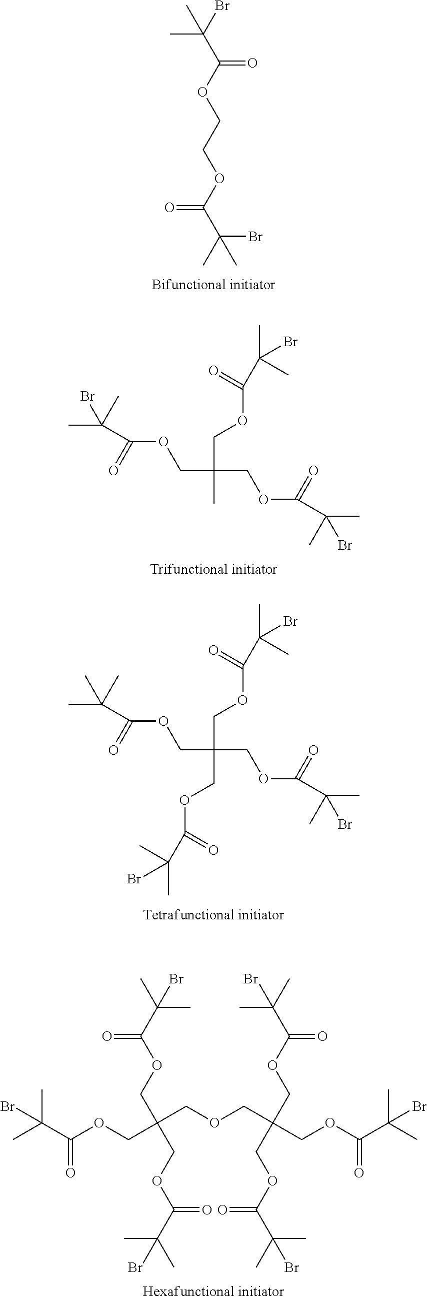

In case of ATRP, a molar ratio of the monomer and the initiator is set to adjust a molecular weight of a polymer. The molar ratio thereof is preferably 100,000/1 to 50/1, more preferably 100,000/1 to 100/1. When the molar ratio is greater than the upper limit, a large amount of the unreacted monomer is remained in the production process, it may be necessary to provide a step for removing the unreacted monomer. When the molar ratio is lower than the lower limit, a molecular weight of a resulting polymer is small, and therefore the polymer may not satisfy the required physical properties. Moreover, the adjustment of the molar ratio is effective in view of a control of polymerization.

Recently, reported is ARGET ATRP where bivalent copper generated in the ATRP system is continuously reducing to active monovalent copper by adding a reducing agent in order to improve a polymerization speed, or simpleness of operations (e.g., Angew Chem, Int Ed, 45(27), 4482(2006)). Since a ratio of the bivalent copper and the monovalent copper is equivalently maintained by adding the reducing agent, a sufficient polymerization speed is maintained even when the monomer is consumed. Moreover, an amount of the copper for use can be reduced to about 0.1 mol % or less by adding an appropriate reducing agent, and therefore this is an even preferable polymerization method when an ultra-high molecular weight polymer is synthesized. The reducing agent used in this method is appropriately selected from reducing agents, which can reduce a metal catalyst containing a metal to an active state at which radical growth species are generated, but the reducing agent is preferably tin 2-ethyl hexanoate.

### RAFT

In case of RAFT, a radical polymerization initiator known in the art can be used, and examples thereof include: peroxide, such as benzoyl peroxide, cumene hydroperoxide, t-butyl hydroperoxide, sodium persulfate, potassium persulfate, and ammonium persulfate; and an azo-based compound, such as azobisisobutyronitrile, azobismethylbutyronitrile, and azobisisovaleronitrile. However, the initiator for use is not limited to those listed above. The initiator that is preferably used is not particularly limited, and examples thereof include 2,2′-azobis(2-methylpropionitrile).

The chain transfer agent (RAFT agent) is preferably appropriately selected depending on a type of the monomer for use. Examples thereof include a thiocarbonyl thio compound, such as dithiobenzoate, trithiocarbonate, dithiocarbamate, and xanthate, but the chain transfer agent is not limited to those listed above. The RAFT agent, which is suitably used, is not particularly limited, and examples thereof include 4-cyano-4-[(dodecylsulfanylthiocarbonyl)sulfanyl]pentanoic acid, cyanomethyl methyl(phenyl)carbamodithioate, and 2-phenyl-2-propyl benzodithioate. By appropriately selecting a substituent of the RAFT agent with respect to the monomer to be polymerized, a polymer product having a narrow molecular weight distribution can be attained with a short reaction time.

In case of RAFT polymerization, a molecular weight of a polymer product to be obtained can be adjusted with a molar ratio of the monomer to the chain transfer agent (RAFT agent). The molar ratio thereof is preferably 100,000/1 to 50/1, more preferably 100,000/1 to 100/1. When the molar ratio is greater than the aforementioned range, an amount of the unreacted monomer is increased in the production process, and therefore it may be necessary to additionally provide a step for removing the unreacted monomer. When the molar ratio is lower than the lower limit, a molecular weight of a polymer to be obtained is small, and therefore the required physical properties may not be satisfied. Moreover, the adjustment of the molar ratio is effective in view of a control of polymerization.

A catalyst is preferably used for polymerization. The catalyst for use is appropriately selected from various catalysts known in the art depending on the polymerization method. In the case where ATRP is used as the polymerization, for example, a metal catalyst containing a metal, such as Cu(0), Cu+, Cu2+, Fe+, Fe2+, Fe3+, Ru2+, and Ru3+, can be used. Among these metal catalysts, a monovalent copper compound containing Cu+ or 0-valent copper is particularly preferable in order to achieve a precise control of a molecular weight or molecular weight distribution of a polymer product to be obtained. Specific examples of the catalyst include Cu(0), CuCl, CuCl2, CuBr, and Cu2O. An amount of the catalyst for use is typically 0.01 mol to 100 mol, preferably 0.01 mol to 50 mol, and more preferably 0.01 mol to 10 mol, relative to 1 mol of the polymerization initiator.

As for the aforementioned metal catalyst, moreover, an organic ligand is typically used. Examples of a ligand atom to the metal include a nitrogen atom, an oxygen atom, a phosphorus atom, and a sulfur atom. Among them, a nitrogen atom, and a phosphorus atom are preferable. Specific examples of the organic ligand include 2,2′-bipyridine and a derivative thereof, 1,10-phenanthroline and a derivative thereof, tetramethyl ethylene diamine, pentamethyl diethylene triamine, tris(dimethylaminoethyl)amine (Me6TREN), triphenylphosphine, tributylphosphine, tris[2-(dimethylamino)ethyl]amine, N-butyl-2-pyridylmethanimine, and 4,4′-dimethyl-2,2′-dipyridyl. In the case where a high molecular weight polymer, such as acrylic acid ester, and methacrylic acid ester, is synthesized, 2,2′-bipyridine and a derivative thereof are preferably used. More preferred is 4,4′-dinonyl-2,2′-bipyridine, which is a derivative of 2,2′-bipyridine. The metal catalyst and the organic ligand may be separately added to be blended in a polymerization system. Alternatively, the metal catalyst and the organic ligand may be mixed in advance, and the mixture is added to a polymerization system. Particularly in the case where a copper compound is used, the former method is preferable.

### NMP

NMP is a polymerization method performed in the presence of a radical initiator and a nitroxide compound, and does not require a catalyst. The nitroxide compound for use in the production method of the present embodiment is a compound having a nitroxide radical segment structure, or a compound that can generate a nitroxide radical segment structure, and examples thereof include 2,2,5-trimethyl-4-phenyl-3-azahexane-3-nitroxide, 2,2,6,6-tetramethyl-1-piperidinyloxyl radical (TEMPO), 2,2,6,6-tetraethyl-1-piperidinyloxyl radical, 2,2,6,6-tetramethyl-4-oxo-1-piperidinyloxyl radical, 2,2,5,5-tetramethyl-1-pyrolidinyloxyl radical, 1,1,3,3-tetramethyl-2-isoindolinyloxy radical, and N,N-di-t-butylamineoxy radical. The nitroxide compound is not however limited to those listed above. The initiator for use in NMP is not particularly limited, and examples thereof include N-tert-butyl-N-(2-methyl-1-phenylpropyl)-O-(1-phenylethyl)hydr oxylamine. Similarly to ATRP, a molar ratio of the monomer to the initiator can be set for adjusting a molecular weight, and the range thereof can be adjusted as in ATRP.

### Additives

Additives may be optionally added for polymerization. Examples of the additives include a surfactant, an antioxidant, a stabilizer, an anticlouding agent, an UV-ray absorber, a pigment, a colorant, inorganic particles, various fillers, a heat stabilizer, a flame retardant, crystal nucleating additives, an antistatic agent, a surface wetting agent, combustion adjuvant, a lubricant, a natural product, a releasing agent, a plasticizer, and other similar agents. Optionally, a polymerization terminator (e.g., benzoic acid, hydrochloric acid, phosphoric acid, metaphosphoric acid, acetic acid, and lactic acid) may be used after the polymerization reaction. A blended amount of the additives is varied depending on the purpose for adding the additives, or a type of the additives, but the amount thereof is preferably 0 parts by mass to 5 parts by mass, relative to 100 parts by mass of the polymer.

As for the stabilizer, epoxidized soybean-oil, or carbodiimide is used. As for the antioxidant, 2,6-di-t-butyl-4-methylphenol, or butylhydroxyanisole is used. As for the anticlouding agent, glycerin fatty acid ester, or monostearyl citrate is used. As for the fillers, clay, talc, or silica each having a function as an UV-ray absorber, a heat stabilizer, a flame retardant, an internal releasing agent, or crystal nucleating additives is used. As for the pigment, titanium oxide, carbon black, or ultramarine blue is used.

### Compressive Fluid

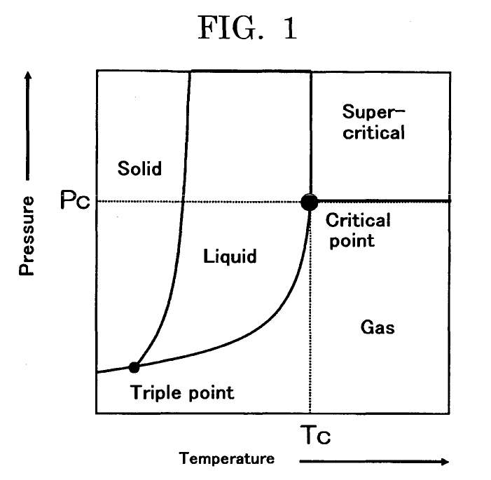

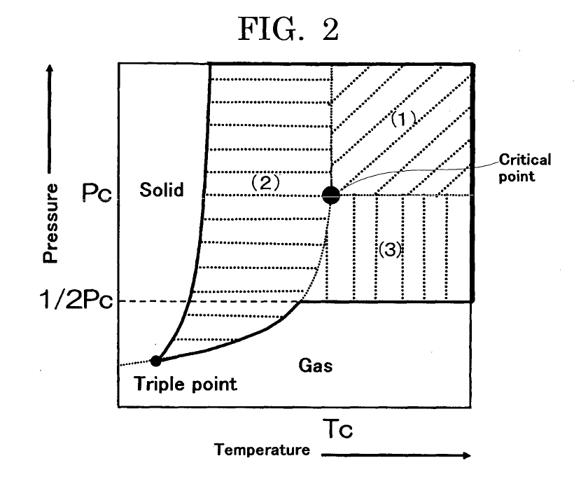

Next, a compressive fluid for use in the production method of the present embodiment is explained with reference to FIGS. 1 and 2. FIG. 1 is a phase diagram illustrating states of a substance with respect to temperature and pressure. FIG. 2 is a phase diagram for defining the range of the compressive fluid in the present embodiment. In the present embodiment, the term “compressive fluid” refers to a state of a substance present in any of the regions (1), (2), or (3) of FIG. 2 in the phrase diagram of FIG. 1.

In such regions, the substance is known to have extremely high density and show different behaviors from those shown at normal temperature and normal pressure. Note that, a substance is a supercritical fluid when it is in the region (1). The supercritical fluid is a fluid that exists as a noncondensable high-density fluid at temperature and pressure exceeding the corresponding critical points, which are limiting points at which a gas and a liquid can coexist. Since the supercritical fluid has intermediate transporting properties in between a liquid and a gas, and has excellent in mass transfer and heat transfer, a polymerization reaction in the supercritical fluid is effective for removing heat of polymerization. When a substance is in the region (2), moreover, the substance is a liquid, but in the present embodiment, it is a liquefied gas obtained by compressing the substance existing as a gas at normal temperature (25° C.) and ambient pressure (1 atm). When a substance is in the region (3), moreover, the substance is in the state of a gas, but in the present embodiment, it is a high-pressure gas whose pressure is ½ or higher than the critical pressure (Pc), i.e. ½Pc or higher.

As for a substance used as a compressive fluid, preferred is a substance, which can plasticize a polymer to be generated without deactivating an initiator or a metal catalyst for use. Such a compressive fluid can reduce a melting point or viscosity of a polymer to be generated, and thus a polymer having a high molecular weight with less monomer residues can be continuously obtained without using an organic solvent at reaction temperature equal to or lower than a melting point of the polymer, by adding the compressive fluid to a system of living polymerization. The compressive fluid capable of plasticizing a polymer to be generated without deactivating a catalyst is not particularly limited, and examples thereof include: carbon monoxide; carbon dioxide; dinitrogen oxide; nitrogen; hydrocarbon, such as methane, ethane, propane, 2,3-dimethylbutane, and ethylene; and ether, such as dimethyl ether, and methyl ethyl ether. Among them, carbon dioxide is preferable, because the critical pressure and critical temperature of carbon dioxide are respectively about 7.4 MPa, and about 31° C., and thus a supercritical state of carbon dioxide is easily formed. In addition, carbon dioxide is non-flammable, and therefore it is easily handled. These compressive fluids may be used alone, or in combination.

According to the present embodiment, a monomer can be melted or dissolved without using an organic solvent by bringing the monomer into contact with a compressive fluid. Note that, in the present embodiment, “melting” denotes a state where raw materials or a generated polymer is plasticized with swelling, or liquidized by being in contact with a compressive fluid. Moreover, “dissolving” denotes a state where raw materials are dissolved in a compressive fluid.

### Polymerization Reaction Device

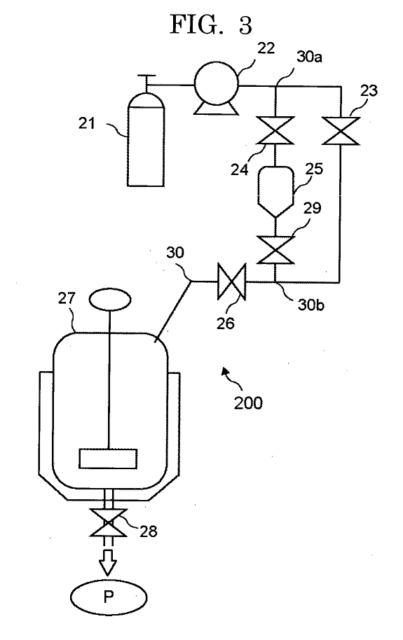

Subsequently, a polymerization reaction device for use in the production of a polymer according to the present embodiment is explained with reference to FIG. 3.

### Batch Polymerization Reaction Device

First, the polymerization reaction is explained with FIG. 3. FIG. 3 is a system diagram illustrating one example of a polymerization step. In the system diagram of FIG. 3, the polymerization reaction device 200 contains a tank 21, a metering pump 22, an addition pot 25, a reaction vessel 27, and valves (23, 24, 26, 28, 29). Each of the aforementioned devices are connected with a pressure resistant pipe 30 as illustrated in FIG. 3. Moreover, connectors (30a, 30b) are provided to the pipe 30.

The tank 21 is configured to store a compressive fluid. Note that, the tank 21 may store a gas or a solid, which is turned into a compressive fluid by being heated or compressed in a supply channel to the reaction vessel 27, or within the reaction vessel 27. In this case, the gas or solid stored in the tank 21 is turned into a state of (1), (2), or (3) of FIG. 2 in the reaction vessel 27 upon application of heat or pressure.

The metering pump 22 is configured to supply the compressive fluid stored in the tank 21 to the reaction vessel 27 at constant pressure and a constant flow rate. The addition pot 25 is configured to store a catalyst to be added to raw materials in the reaction vessel 27. The valves (23, 24, 26, 29) are configured to switch between a path for supplying the compressive fluid stored in the tank 21 to the reaction vessel 27 via the addition pot 25, and a path for supplying the compressive fluid to the reaction vessel 27 without going through the addition pot 25, by opening and closing.

The reaction vessel 27 is configured to store a monomer and an initiator in advance to initiate polymerization. The reaction vessel 27 is a pressure resistant vessel for polymerizing the monomer by bringing the monomer and initiator stored in advance into contact with the compressive fluid supplied from the tank 21 and the catalyst supplied from the addition pot 25. Note that, the reaction vessel 27 may be provided with a gas outlet for removing evaporated products. Moreover, the reaction vessel 27 is equipped with a heater configured to heat the raw materials and the compressive fluid. Furthermore, the reaction vessel 27 is equipped with a stirring device configured to stir the raw materials and the compressive fluid. Since a settlement of a generated polymer is prevented by stirring with the stirring device, when there is a difference in the density between the raw materials and the generated polymer, a polymerization reaction can be carried out more uniformly and quantitatively. The polymer product P in the reaction vessel 27 is discharged by opening the valve 28 after completing the polymerization reaction.

### Serial Polymerization Reaction Device

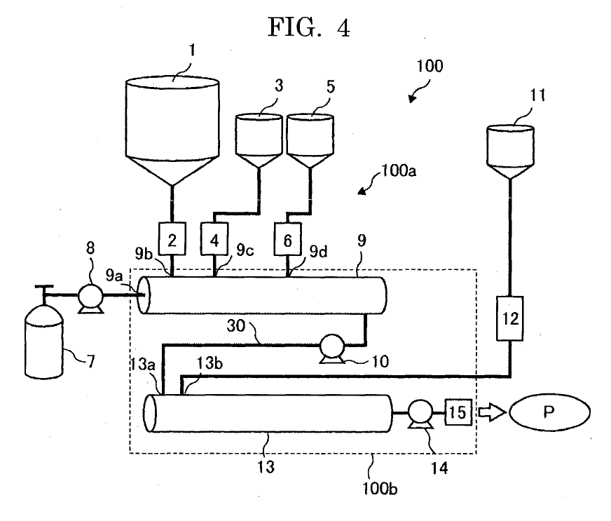

Subsequently, the polymerization reaction device 100 is explained with reference to FIG. 4. FIG. 4 is a system diagram illustrating one example of a polymerization step. When an addition polymerizable monomer containing a vinyl group is polymerized through living polymerization in accordance with a conventional production method, a polymer cannot be continuously attained, as a polymer product is solidified during the reaction. In accordance with the production method of the present embodiment, a polymer can be continuously produced by using, for example, the polymerization reaction device 100 illustrated in FIG. 4.

In the system diagram of FIG. 4, the polymerization reaction device 100 contains a supply unit 100a configured to supply a raw material, such as a monomer, and a compressive fluid, and a main body 100b of the polymerization reaction device as one example of a serial polymerization device configured to polymerize a monomer supplied by the supply unit 100a. The supply unit 100a contains tanks (1, 3, 5, 7, 11), metering feeders (2, 4), and metering pumps (6, 8, 12). The polymerization reaction device main body 100b contains a blending device 9 provided at one end of the polymerization reaction device main body 100b, a feeding pump 10, a reaction vessel 13, a metering pump 14, and an extrusion cap 15 provided at the other end of the polymerization reaction device main body 100b.

The tank 1 of the supply unit 100a is configured to store a monomer. The monomer to be stored may be a powder, or of a melted state. The tank 3 is configured to store solids (a powder or granules) among the initiator and additives. The tank 5 is configured to store liquids among the initiator and the additives. The tank 7 is configured to store the compressive fluid. Note that, the tank 7 may store a gas or a solid, which is turned into a compressive fluid by being heated or compressed during it is supplied to the blending device 9, or within the blending device 9. In this case, the gas or solid stored in the tank 7 is turned into a state of (1), (2), or (3) of FIG. 2 in the blending device 9 upon application of heat or pressure.

The metering feeder 2 configured to measure the monomer stored in the tank 1 and to continuously supply the monomer to the blending device 9. The metering feeder 4 is configured to measure the solid stored in the tank 3 and to continuously supply the solid to the blending device 9. The metering pump 6 is configured to measure the liquid stored in the tank 5 and to continuously supply the liquid to the blending device 9. The metering pump 8 is configured to continuously supply the compressive fluid stored in the tank 7 to the blending device 9 at the constant pressure and the constant flow rate.

Note that, the phrase “continuously supply” used in the present embodiment is a concept with respect to a method for supplying per batch, and means supplying in a manner that a polymer is continuously attained. Specifically, each material may be intermittently supplied as long as a polymer is continuously attained. In the case where the initiator and the additives are all solids, the polymerization reaction device 100 may not contains the tank 5 and the metering pump 6. In the case where the initiator and the additives are all liquids, similarly, the polymerization reaction device 100 may not contain the tank 3 and the metering feeder 4.

In the present embodiments, each of the aforementioned devices of the polymerization reaction device main body 100b are connected with pressure resistant piping 30 configured to transport the raw materials, the compressive fluid, or a generated polymer, as illustrated in FIG. 4. Moreover, the blending device 9, feeding pump 10, and reaction vessel 13 of the polymerization reaction device each have a tubular member configured to pass through the aforementioned raw materials.

The blending device 9 of the polymerization reaction device 100b is a device containing a pressure resistant vessel configured to continuously bringing the raw materials, such as the monomer, the initiator, and the additives, each supplied from the tanks (1, 3, 5) into contact with the compressive fluid supplied from the tank 7 to dissolve or melt the raw materials. In the blending device 9, the raw materials are dissolved or melted by bringing the raw materials into contact with the compressive fluid. Note that, in the present embodiment, “melting” denotes a state where raw materials or a generated polymer is plasticized with swelling, or liquidized by being in contact with a compressive fluid. Moreover, “dissolving” denotes a state where raw materials are dissolved in a compressive fluid.

In the case where the monomer is dissolved, a fluid phase is formed. In the case where the monomer is melted, a melt phase is formed. It is preferred that one phase of either the melt phase or the fluid phase be formed in the blending device 9 in order to carry out a reaction uniformly. In order to carry out the reaction at a high ratio of the raw materials to the compressive fluid, the monomer is preferably melted in the blending device 9. Note that, in the present embodiment, the raw materials, such as the monomer, and the compressive fluid can be continuously brought into contact with each other in the blending device 9 at the constant ratio of concentration, by continuously supplying the raw materials and the compressive fluid. As a result, the raw materials can be efficiently dissolved, or melted.

Since the raw materials, such as the monomer, and the compressive fluid can be continuously brought into contact with each other at the constant concentration ratio in the present embodiment, the raw materials can be efficiently melted with the compressive fluid. A shape of the blending device 9 may be a tank shape, or a tube shape, but the shape thereof is preferably a tube shape from one end of which the raw materials are supplied, and from the other end of which the mixture is taken out. To the vessel of the blending device 9, an inlet 9a configured to introduce the compressive fluid supplied from the tank 7 by the metering pump 8, an inlet 9b configured to introduce the monomer supplied from the tank 1 by the metering feeder 2, an inlet 9c configured to introduce the powder supplied from the tank 3 by the metering feeder 4, and an inlet 9d configured to introduce the liquid supplied from the tank 5 by the metering pump 6 are provided.

In the present embodiment, each inlet (9a, 9b, 9c, 9d) is composed of a connector configured to connect the vessel of the blending device 9 and each pipe configured to transport each raw material or the compressive fluid. The connector is not particularly limited, and is selected from conventional connectors, such as a reducer, a coupling, a Y-type connector, a T-type connector, and an outlet. Moreover, the blending device 9 contains a heater configured to heat the supplied raw materials or compressive fluid.

Furthermore, the blending device 9 may contain a stirring device configured to stir the raw materials and the compressive fluid. In the case where the blending device 9 contains a stirring device, the stirring device is preferably a single screw stirring device, a twin-screw stirring device where screws are engaged with each other, a biaxial mixer containing a plurality of stirring elements which are engaged or overlapped with each other, a kneader containing spiral stirring elements which are engaged with each other, or a static mixer. Particularly, the twin-screw or multi-screw stirring device where screws are engaged with each other is preferable, as there is less depositions of a reaction product to the stirring device or the vessel, and they have a self-cleaning function.

In the case where the blending device 9 does not contain a stirring device, a pressure resistant pipe is suitably used as the blending device 9. In this case, an installation space of the polymerization reaction device 100 can be reduced, or freedom of layout thereof can be improved by arranging the pressure resistant pipe spirally, or in a folded manner. Note that, in the case where the blending device 9 does not contain the stirring device, the monomer supplied to the blending device 9 is preferably liquidized in advance in order to surely mixing all the materials in the blending device 9. Note that, in the case where the blending device 9 does not contain the stirring device, the monomer supplied to the blending device 9 is preferably in a melted-state in order to surely mixing all the materials in the blending device 9.

The feeding pump 10 is configured to send the materials melted in the blending device 9 to the reaction vessel 13. The tank 11 is configured to store a catalyst. The metering pump 12 is configured to measure the catalyst stored in the tank 11 and to supply the catalyst to the reaction vessel 13.

The reaction vessel 13 is a pressure resistant vessel configured to mix the melted raw materials sent by the feeding pump 10 and the catalyst supplied by the metering pump 12 to polymerize the monomer. A shape of the reaction vessel 13 may be a tank shape or a tube shape, but the tube shape is preferable, as it gives less dead-space. To the reaction vessel 13, an inlet 13a configured to introduce all the materials mixed in the blending device 9, and an inlet 13b configured to introduce the catalyst supplied from the tank 11 by the metering pump 12 to the vessel are provided. In the present embodiment, each inlet (13a, 13b) is composed of a connector configured to connect the reaction vessel 13 to a pipe for transporting each raw material. The connector is not particularly limited, and a conventional coupling, such as a reducer, a coupling, a Y-type connector, a T-type connector, and an outlet, is used as the connector.

Note that, the reaction vessel 13 may be provided with a gas outlet for removing evaporated products. Moreover, the reaction vessel 13 contains a heater configured to heat the fed raw materials. Furthermore, the reaction vessel 13 may contain a stirring device configured to stir the raw materials and the compressive fluid. In the case where the reaction vessel 13 contains a stirring device, a settlement of a generated polymer is prevented with a difference in the density between the raw materials and a generated polymer, and therefore a polymerization reaction can be carried out more uniformly and quantitatively. As for the stirring device of the reaction vessel 13, preferred is a dual- or multi-axial stirrer having screws engaging with each other, stirring elements of 2-flights (rectangle), stirring elements of 3-flights (triangle), or circular or multi-leaf shape (clover shape) stirring wings, in view of self-cleaning. In the case where raw materials including the catalyst are sufficiently mixed in advance, a motionless mixer, which performs division and compounding (recombining) of the flows in multiple stages by a guiding device, can also be used as the stirring device. Examples of the static mixer include: multiflux batch mixers disclosed in Japanese examined patent application publication (JP-B) Nos. 47-15526, 47-15527, 47-15528, and 47-15533; a Kenics-type mixer disclosed in Japanese Patent Application Laid-Open (JP-A) No. 47-33166; and motionless mixers similar to those listed. There are incorporated herein by reference.

In the case where the reaction vessel 13 is not equipped with a stirring device, a pressure resistant pipe is suitably used as the reaction vessel 13. In this case, an installation space of the polymerization reaction device 100 can be reduced, or freedom of lay-out can be improved by providing the pressure resistant pipe in a spiral or folded manner.

In FIG. 4, an example where one reaction vessel 13 is provided is illustrated, but two or more reaction vessels 13 can be used. In the case where a plurality of the reaction vessels 13 are used, the reaction (polymerization) conditions per reaction vessel 13, e.g., temperature, catalyst concentration, pressure, average retention time, and stirring speed, may be identical, but it is preferred that optimal conditions for each reaction vessel be selected depending on the progress of the polymerization. Note that, it is not very good idea that excessively large number of the vessels is connected to give many stages, as it may extend a reaction time, or a device may become complicated. The number of the stages is preferably 1 to 4, more preferably 1 to 3.

In the case where polymerization is performed by means of a device having only one reaction vessel, it is typically believed that such a device is not suitable for industrial production, as a degree of polymerization of a polymer to be attained, or an amount of monomer residues in the polymer is unstable and tends to be varied. It is considered that the instability thereof is caused by coexistence of the raw materials having the melt viscosity of a few poises to several tends poises, and the polymerized polymer having the melt viscosity of about 1,000 poises. In the present embodiment, on the other hand, it is possible to reduce a difference in the viscosity within the system by dissolving or melting the raw materials and the generated polymer in the compressive fluid, and therefore a number of stages can be reduced compared to those of a conventional polymerization reaction device.

The metering pump 14 is configured to discharge a polymer compound as the polymer product P in the reaction vessel 13 to outside of the reaction vessel 13 through an extrusion cap 15 as one example of the polymer outlet. Note that, the polymer product P can be also discharged from the reaction vessel without using the metering pump 14 by utilizing the pressure difference between inside and outside the reaction vessel 13. In this case, a pressure control valve may be used instead of the metering pump 14 in order to adjust the internal pressure of the reaction vessel 13, or the discharging rate of the polymer product P.

### Polymerization Method

Subsequently, a polymerization method using the raw materials, the compressive fluid, and the polymerization reaction device 100 or the polymerization reaction device 200 is explained. In accordance with the polymerization method of the present embodiment, after bringing raw materials containing an addition polymerizable monomer containing a vinyl group, which can be living polymerizable, into contact with a compressive fluid to melt of dissolve the addition polymerizable monomer containing a vinyl group, the addition polymerizable monomer containing vinyl group is polymerized through living polymerization in the presence of an initiator and a metal catalyst. As a result, a polymer product is not solidified as the reaction progresses even when the polymerization is carried out under the reaction conditions that are equal to or lower than the melting point or softening point of the polymer product, and a degree of freedom is secured when the polymer product is taken out from a reaction vessel. As for the living radical polymerization method, living radical polymerization using dormant species is effective.

The polymerization reaction temperature (set temperature of the reaction vessel (13, 27)) is not particularly limited. In case of ATRP, for example, the polymerization reaction temperature is typically 40° C. to 200° C., preferably 40° C. to 150° C., and even more preferably 40° C. to 130° C.

The polymerization is preferably carried out without any solvent, as there is no need to remove a solvent afterwards.

In the present embodiment, the polymerization reaction time (the average retention time in the reaction vessel (13, 27)) is set according to a target molecular weight. In the case where the target molecular weight is 5,000 to 1,000,000, the polymerization reaction time is, for example, 2 hours to 48 hours.

The catalyst remained in the polymer product obtained in the present embodiment is removed according to the necessity. The removal method is not particularly limited, and examples thereof include vacuum distillation, and extraction using a compressive fluid. In the case where the vacuum distillation is performed, the vacuuming conditions are set based on the boiling point of the catalyst. For example, the temperature for vacuuming is 100° C. to 120° C., and the catalyst can be removed at temperature lower than the temperature at which the polymer product is depolymerized. Therefore, the compressive fluid is preferably used as a solvent in the extraction process. As for such an extraction process, a conventional technique, such as extraction of perfume, can be applied.

In the production method of the present embodiment, a rate of the addition polymerization monomer transformed into a polymer through living polymerization (polymerization rate) is 98% by mass or higher, preferably 99% by mass or higher. That means that an amount of the monomer residues in the polymer is 2% by mass or less, preferably 1% by mass or less. When the polymerization rate is lower than 98% by mass, durability of a resulting polymer product may be insufficient as a polymer material, or an operation for removing the addition polymerizable monomer may be additionally required. In the present embodiment, the polymerization rate means a ratio of an amount of the addition polymerizable monomer contributing the generation of a polymer to a total amount of the addition polymerizable monomer as a raw material. The amount of the monomer contributing the generation of a polymer can be determined by deducting an amount of the unreacted addition polymerizable monomer from an amount of the generated polymer.

The weight average molecular weight of the polymer obtained in the present embodiment can be adjusted with an amount of the initiator. The weight average molecular weight of the polymer is not particularly limited, but it is typically 5,000 to 1,000,000. When the weight average molecular weight is greater than 1,000,000, it may not be economical as productivity is deteriorated due to an increase in the viscosity. When the weight average molecular weight thereof is smaller than 5,000, such the polymer may not be preferable, as strength thereof is insufficient.

The number average molecular weight of the polymer of the present embodiment can be appropriately adjusted depending on use thereof, but it is 15,000 or greater. Although the number average molecular weight of the polymer of the present embodiment is not particularly limited, the number average molecular weight thereof is 800,000 or smaller. Note that, in the present embodiment, the number average molecular weight is measured by gel permeation chromatography (GPC). When the number average molecular weight thereof is smaller than 15,000, applied use thereof may be limited, as the polymer is brittle. The value obtained by dividing the weight average molecular weight Mw of the polymer of the present embodiment with the number average molecular weight Mn thereof (molecular weight distribution: Mw/Mn) is preferably 1.0 to 1.2. When this value is greater than 1.2, an amount of a low molecular weight component increases to thereby reduce stability.

### Use of Polymer

The polymer product obtained in the production method of the present embodiment is produced by the production method that does not use an organic solvent. In the case where the polymer product of the present embodiment is produced by the production method that does not use an organic solvent and a metal catalyst, moreover, the polymer product has excellent safety and stability, as the polymer product is substantially free from a metal atom and an organic solvent, and contains less monomer residues. Note that, the organic solvent is an organic compound that is a liquid at room temperature (25° C.), and ambient pressure, and is different from a compressive fluid. Accordingly, the particles of the present embodiment are widely used as various applications, such as commodities, pharmaceutical products, cosmetic products, and electrophotographic toner. Note that, in the present embodiment, the metal catalyst means a catalyst, which is used for polymerization and contains a metal. Moreover, the phrase “substantially free from a metal atom” means that a metal atom derived from a metal catalyst is not contained. Specifically, it can be said that a polymer product does not contain a metal atom, when the metal atom derived from the metal catalyst in the polymer product is detected by a conventional analysis method, such as ICP-atomic emission spectrometry, atomic absorption spectrophotometry, and colorimetry, and the result is lower than the detection limit (10 ppm). The metal catalyst is not particularly limited, and examples thereof include those listed above. In the present embodiment, moreover, the term “organic solvent” is an organic compound, which is used for dissolving other substances, is a liquid at room temperature, and ambient pressure, and is dissolve a polymer product obtained from a polymerization reaction in the present embodiment. Examples of the organic solvent include: a halogen solvent, such as chloroform, and methylene chloride; and tetrahydrofuran. The phrase “substantially free from an organic solvent” means that an amount of the organic solvent in the polymer product measured by the following method is below the detection limit (5 ppm).

(Measuring Method of Residual Organic Solvent)

To 1 part by mass of the polymer product to be measured, 2 parts by mass of 2-propanol is added, and dispersed by ultrasonic wave for 30 minutes. Thereafter, the resultant is stored in a refrigerator (5° C.) for 1 day or longer, to thereby extract the organic solvent contained in the polymer product. The supernatant liquid is analyzed by gas chromatography (GC-14A, manufactured by Shimadzu Corporation) to determine the amount of the organic solvent and the residual monomers in the polymer product. Thus, the concentration of the organic solvent is measured. The measurement conditions of the analysis are as follows:

### Device: Shimadzu GC-14A

### Column: CBP20-M 50-0.25

### Detector: FID

Injection volume: 1 μL to 5 μL
Carrier gas: He 2.5 kg/cm²
Flow rate of hydrogen: 0.6 kg/cm²
Flow rate of air: 0.5 kg/cm²
Chart speed: 5 mm/min

### Sensitivity: Range 101×Atten 20

Column temperature: 40° C.
Injection temperature: 150° C.

The polymer obtained by the production method of the present embodiment is, for example, formed into particles, a film, a sheet, a molded article, or fibers, to be widely used, for example, for commodities, industrial materials, agricultural products, sanitation materials, medical products, cosmetic products, electrophotographic toner, packaging materials, materials of electric devices, housings of appliances, and materials for automobiles.

### Film

In the present embodiment, the film is a polymer component formed into a thin film having a thickness of less than 250 μm. In the present embodiment, the film is produced by drawing the polymer product obtained by the aforementioned production method.

In this case, the drawing method is not particularly limited, but a uniaxial drawing method, and concurrent or simultaneous biaxial drawing method (e.g., a tubular method, and a tenter method, which is applied for drawing of a common plastic, can be employed.

A film is generally formed in a temperature range of 150° C. to 280° C. The formed film is subjected to monoaxial or biaxial drawing by a roll method, a tenter method, or a tublar method. The drawing temperature is typically 30° C. to 110° C., preferably 50° C. to 100° C. A draw magnification is typically 0.6 times to 10 times each in a longitudinal direction and a transverse direction. Moreover, after drawing, a heat treatment may be performed, and examples of such heat treatment include a method for blowing hot air, a method for applying infrared rays, a method for applying microwaves, and a method for bringing into contact with a heat roller.

In accordance with the aforementioned drawing method, various stretched films, such as a stretched sheet, a flat yarn, a stretched tape or band, a tape with linear supports, and a split yarn can be obtained. A thickness of the stretched film is appropriately selected depending on use thereof, but it is typically 5 μm or greater, but less than 250 μm.

Note that, the formed stretched film may be subjected to various secondary treatments for various purposes in order to impart surface functions, such as a chemical function, electrical function, magnetic function, mechanical function, frictional, abrasive or lubricant function, optical function, thermal function, and biocompatibility. Examples of the secondary treatment include embossing, coating, bonding, printing, metalizing (plating etc.), machining, and surface treatments (e.g., an antistatic treatment, a corona discharge treatment, a plasma treatment, a photochromism treatment, physical vapor deposition, chemical vapor deposition, and coating).

The stretched film obtained in the present embodiment is excellent in safety and stability because the stretched film uses the polymer product produced by the production method that does not use a metal catalyst and an organic solvent, does not contain the metal catalyst and the organic solvent, and contains an extremely small amount of the monomer residues, that is 2% by mass or smaller. Accordingly, the stretched film of the present embodiment can be widely applied in various applications, such as commodities, packaging materials, medical products, materials of electric devices, housings of appliances, and materials for automobiles. Taking advantage of the polymer product being free from a solvent or a metal, the stretched film is effective for use where it is possibly taken into human bodies, such as packaging materials particularly for food, cosmetic products, and medical materials, such as pharmaceutical products.

### Molded Article

In the present embodiment, the molded article is an article obtained by processing with a mold. The definition of the molded article includes parts formed of a molded article, such as handles of a tray, and a product equipped with a molded article, such as a tray provided with handles, as well as a molded article itself.

The processing method is not particularly limited, and the processing can be performed by a conventional method for a thermoplastic resin. Examples thereof include injection molding, vacuum molding, compression molding, vacuum compression molding, and press molding. In this case, a molded article may be attained by melting the polymer product obtained in the aforementioned production method, followed by injection molding. The processing conditions for giving a shape to the polymer product are appropriately determined depending on a type of the polymer product, and a device for use. In the case where a shape is given to a sheet of the polymer product of the present embodiment through press molding using a mold, for example, the temperature of the mold can be set to the range of 100° C. to 150° C. In the case where a shape is given by injection molding, the polymer product heated to the range of 150° C. to 250° C. is injected into a mold, and the temperature of the mold is set to the approximate range of 20° C. to 80° C., to thereby perform inject molding.

Conventionally, a generally used polymer contains large residual rates of a metal catalyst, an organic solvent, and a monomer. When such the polymer is heated to form into a film, for example, a resulting sheet has impaired appearance due to a fish-eye defect that is a residue, such as a metal catalyst, organic solvent, and monomer, appeared on the sheet, and strength of the sheet may decrease. When such the polymer is shaped by molding with a mold, or injection molding, moreover, the appearance may be impaired similarly to the above, and the strength may decrease.

On the other hand, the film and molded article of the present embodiment use the polymer product produced by the production method that does not use an organic solvent, and has an extremely small amount of the monomer residues, that is 2% by mass or less. Therefore, the molded article obtained by the present embodiment is excellent in safety, stability, and appearance.

The polymer product obtained in the aforementioned production method can be also applied for fibers, such as monofilaments, and multifilaments. Note that, in the present embodiment, the definition of the fibers include not only sole fibers, such as monofilaments, but also an intermediate product constituted of fibers such as a woven fabric, and nonwoven fabric, and a product containing a woven fabric or nonwoven fabric, such as a mask.

In the present embodiment, in the case of monofilaments of the fibers, the fibers are produced by melt-spinning the polymer product obtained in the aforementioned production method, cooling, and drawing in accordance with a conventional method, to thereby form the polymer product into fibers. Depending on use, a coating layer may be formed on each monofilament in accordance with a conventional method, and the coating layer may contain an antifungal agent, and a colorant. In the case of a nonwoven fabric, moreover, the fibers are produced, for example, by melt spinning the polymer product, cooling, drawing, splitting, depositing, and performing a heat treatment, to thereby form the polymer product into a nonwoven fabric. The polymer product may contain additives such as an antioxidant, a flame retardant, an UV absorber, an antistatic agent, an antifungal agent, and a binder resin. The additives may be mixed during the polymerization reaction, or in a post step after the polymerization reaction. Alternatively, the additives may be added to and mixed with the polymer product taken out from the reaction vessel, during the melt-kneading.

The fibers obtained in the present embodiment are excellent in safety and stability because it is formed by using the polymer product produced by the production method without using a metal catalyst and an organic solvent, and therefore the fibers do not include a metal catalyst and an organic solvent, and has an extremely small amount of the monomer residues, that is 2% by mass or smaller. In case of the monofilaments, therefore, the fibers of the present embodiment are widely applied in various applications, such as fishing lines, fishing nets, surgical sutures, medical materials, materials of electric devices, materials for automobiles, and industrial materials. In case of nonwoven fabric, the fibers of the present embodiment are widely applied in various applications, such as fishery or agricultural materials, construction materials, interior accessories, automotive members, packaging materials, commodities, and sanitary materials.

### Effects of Present Embodiment

In a conventional radical polymerization method of a monomer containing a vinyl group, solution polymerization is performed using a solvent, and therefore it is necessary to provide a step for removing the solvent in order to use an obtained polymer product as a solid. In accordance with a conventional bulk polymerization method, a polymerization rate is low, and an unreacted monomer is remained in a resulting polymer product. Therefore, there are cases where it is necessary to provide a step for removing an unreacted monomer with an organic solvent. Specifically, in any of the conventional methods, cost-up due to the increased number of steps, or low yield cannot be avoided. In accordance with the polymerization method of the present embodiment, a polymer, which is excellent in cost efficiency, environmental friendliness, energy saving, resource saving, fabricability, and thermostability can be provided by controlling a feeding rate of a compressive fluid.

Moreover, the production method of the present embodiment exhibits the following effect.

(1) In the case where an addition polymerizable monomer containing a vinyl group is polymerized through bulk polymerization in accordance with a conventional living radical polymerization method, a polymer product is solidified as the reaction progresses under the reaction conditions that are equal to or lower than a melting point or softening point of a polymer product, e.g., 100° C. or lower, and therefore the latter reaction may be unevenly carried out, or unreacted monomers are remained.

In accordance with the production method of the present embodiment, it is possible to take out a polymer product in a melted state even when polymerization is carried out at temperature equal to or lower than a melting point and/or softening point of the polymer at room temperature, the degree of freedom for a shape of the polymer product, or for taking out the polymer product from a reaction vessel is improved. Moreover, it is also possible to continuously produce a polymer. Note that, the phrase “the degree of freedom for a shape of the polymer product, or for taking out the polymer product from a reaction vessel is improved” means that a shape of the polymer product or a method for taking out the polymer product, which has not been realized in a conventional production method where the polymer product is solidified in the middle of the reaction, is realized. Examples of such the method include a method where a polymer composition in the reaction vessel is taken out in the form of a strand. Examples of the shape include a pellet obtained by cutting the polymer product taken out in the strand as it is, and a film obtained by shaping the polymer product.

(2) Compared to the case where an addition polymerizable monomer containing a vinyl group is polymerized through living polymerization in the melted state at the temperature equal to or higher than a melting point of a polymer product to be produced in accordance with a conventional production method, generation of heat due to the reaction is easily suppressed, and the reaction progresses at low temperature, and therefore a molecular weight of a polymer product can be easily increased without causing a side reaction. Moreover, a polymer product having no unreacted monomer residue and having a narrow molecular weight distribution can be easily attained. As a result, a purification step for removing the addition polymerizable monomer, or a solvent in order to attain a polymer having excellent fabricability and thermostability, or no to use the solvent, can be simplified or omitted.
(3) In living polymerization of the addition polymerizable monomer containing a vinyl group, the reaction is performed at relatively low temperature (equal to or lower than a melting point and/or softening point of a polymer to be generated), and a high concentration (the reaction in the bulk-state), and therefore a polymer can be attained in a short period of time.
(4) In a polymerization method using an organic solvent, it is necessary to provide a step for removing the solvent in order to use an obtained polymer as a solid. Since the polymer product of the present embodiment is produced as a dried polymer with a one-stage step without using a solvent, and generating a waste liquid, as a compressive fluid is used, and therefore a drying step is also simplified or omitted.
(5) Both the polymerization speed and polymerization efficiency (a ratio of a polymer in a polymerization system) can be improved by controlling a feeding rate of a compressive fluid through control of the temperature and pressure within the polymerization system.

### EXAMPLES

The present embodiment is more specifically explained through Examples and Comparative Examples, hereinafter, but Examples shall not be construed as to limit the scope of the present invention in any way. Note that, a molecular weight and molecular weight distribution of a polymer obtained in each of Examples and Comparative Examples, and a residual amount of a monomer and oligomer therein were measured in the following manners.

### Measurement of Molecular Weight of Polymer

A molecular weight of a polymer was measured by gel permeation chromatography (GPC) under the following conditions.

Apparatus: GPC-8020 (product of TOSOH CORPORATION)
Column: TSK G2000HXL and G4000HXL (product of TOSOH CORPORATION)

### Temperature: 40° C.

### Solvent: Tetrahydrofuran (THF)

Flow rate: 1.0 mL/min

The polymer (1 mL) having a polymer concentration of 0.5% by mass was injected, and a molecular weight distribution of the polymer was measured under the conditions above using a calibration curve of a molecular weight prepared with a monodisperse polystyrene standard sample, to thereby calculate the number average molecular weight Mn and weight average molecular weight Mn of the polymer. The molecular weight distribution is a value (Mw/Mn) calculated by dividing Mw with Mn. An amount of the monomer residues was calculated from a peak area ratio of the polymer to the monomer.

### Monofilament Tensile Strength

The monofilament tensile strength was measured under conditions of constant extension specified in JIS L1030 8.5.1 standard test.

Device: UCT-100 Tensilon universal tensile testing machine (manufactured by Orientec Co., Ltd.)
Grip interval: 30 cm
Tensile speed: 30 cm/min
Number of test performed: 10 times

### Example 1

Polymerization of methyl methacrylate (MMA) was performed by means of the polymerization reaction device 200 of FIG. 3. Note that, a ¼-inch SUS316 pipe was sandwiched with valves (24, 29), and was used as an addition pot 25. The addition pot 25 was charged with tin 2-ethylhexanoate (0.02 mL, 0.05 mmol) as a reducing agent in advance.

To the reaction vessel 27, cupric chloride (70.0 mg, 0.5 mmol) as a catalyst, tris[2-(dimethylamino)ethyl]amine (manufactured by Sigma-Aldrich Co., LLC.)(0.244 g, 1.10 mmol) as a ligand for an ATRP catalyst, and ethyl 2-bromoisobutyrate (0.45 g, 0.0024 mol) as an ATRP initiator were added. Methyl methacrylate (MMA) (50.0 mL, 0.47 mol), from which a polymerization inhibitor had been removed through an alumina column, was added to the reaction vessel 27 in a manner that a molar ratio of the monomer to the initiator was to be 2,000/1.

The metering pump 22 was operated, and the valves (23, 26) were released to supply carbon dioxide stored in the tank 21 to the reaction vessel 27 without passing through the addition pot 25. The internal temperature of the reaction vessel 27 was set to 80° C., and the reaction vessel 27 was charged with carbon dioxide until the pressure was to be 15 MPa. As a result, methyl methacrylate was brought into contact with carbon dioxide serving as a compressive fluid, to thereby melt the methyl methacrylate. Subsequently, the addition pot 25 was compressed with carbon dioxide. When the pressure reached to equal to or higher than the pressure of the reaction vessel 27 (15 MPa), the valves (24, 29) were opened to supply the reducing agent solution in the addition pot 25, tin 2-ethylhexanoate (0.02 mL, 0.05 mmol), into the reaction vessel 27, to thereby initiate polymerization. Forty hours later when the reaction was completed, the valve 28 was released to take out the polymer product in the reaction vessel 27. The polymer product (PMMA) was solidified after being taken out. The weight average molecular weight, and molecular weight distribution of the polymer product (PMMA) and an amount of monomer residues therein determined by the aforementioned methods are presented in Table 1.

### Examples 2 to 5

Polymers of Examples 2 to 5 were each obtained in the same manner as in Example 1, provided that the initiator was replaced with an equimolecular amount of the following bifunctional initiator (Example 2), trifunctional initiator (Example 3), tetrafunctional initiator (Example 4), or hexafunctional initiator (Example 5). The physical properties of the obtained polymers measured by the aforementioned methods are presented in Table 1.

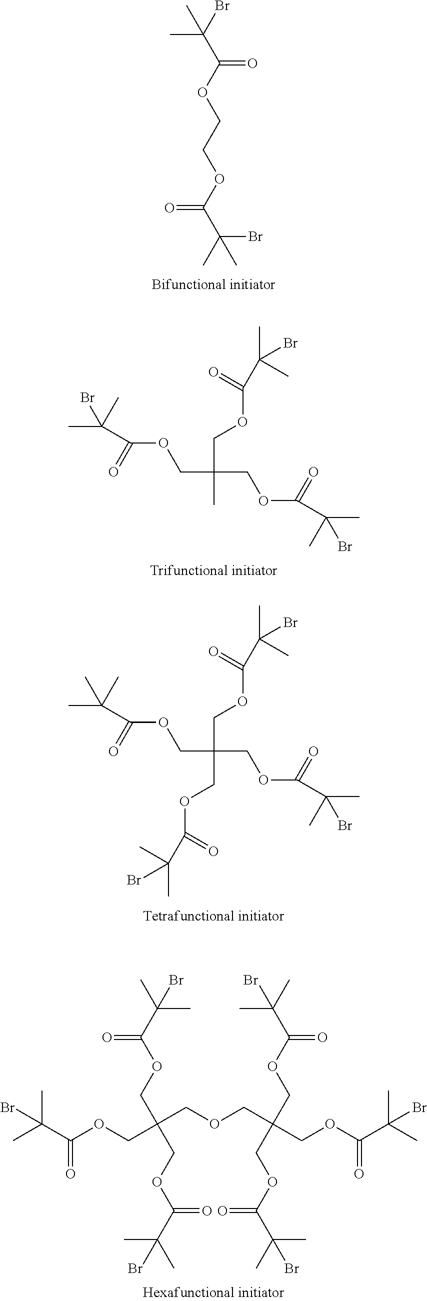

### Examples 6 to 9

Polymers of Examples 6 to 9 were each obtained in the same manner as in Example 1, provided that the reaction temperature and the reaction pressure were changed as depicted in the columns of Examples 6 to 9 in Table 2, respectively. The physical properties of the obtained polymers measured by the aforementioned methods are presented in Table 2.

### Examples 10 to 11

Polymers of Examples 10 to 11 were each obtained in the same manner as in Example 1, provided that the ligand for the catalyst was replaced with an equimolecular amount of 4,4′-dimethyl-2,2′-dipyridyl (Example 10), or N-butyl-2-pyridylmethanimine (Example 11). The physical properties of the obtained polymers measured by the aforementioned methods are presented in Table 3.

### Examples 12 to 13

Polymers of Examples 12 to 13 were each obtained in the same manner as in Example 1, provided that the monomer was replaced with an equimolecular amount of styrene (Example 12), and methyl methacrylate (MMA) and methyl acrylate (MA)(adjusted to give a blending ratio of 10:1 based on mol %)(Example 13). The physical properties of the obtained polymers measured by the aforementioned methods are presented in Table 3.

### Example 14

Polymerization was performed to produce a block polymer of methyl methacrylate (MMA) and methyl acrylate (MA) by means of the polymerization reaction device 200 of FIG. 3.

Note that, a ¼-inch SUS316 pipe was sandwiched with valves (24, 29), and was used as an addition pot 25. The addition pot 25 was charged with tin 2-ethylhexanoate (0.02 mL, 0.05 mmol) as a basic metal catalyst, in advance.

To the reaction vessel 27, cupric chloride (70.0 mg, 0.5 mmol) as a metal catalyst, 4,4′-dimethyl-2,2′-dipyridyl (manufactured by Sigma-Aldrich Co., LLC.) (24.4 mg, 0.11 mmol) as a ligand for an ATRP catalyst, and ethyl 2-bromoisobutyrate as an ATRP initiator were added. Methyl methacrylate (MMA) (26.3 mL, 0.25 mol), from which a polymerization inhibitor had been removed through an alumina column, was added to the reaction vessel 27 in a manner that a molar ratio of the monomer to the initiator was to be 1,100/1.

The metering pump 22 was operated, and the valves (23, 26) were released to supply carbon dioxide stored in the tank 21 to the reaction vessel 27 without passing through the addition pot 25. The internal temperature of the reaction vessel 27 was set to 80° C., and the reaction vessel 27 was charged with carbon dioxide until the pressure was to be 15 MPa. As a result, methyl methacrylate was brought into contact with carbon dioxide serving as a compressive fluid, to thereby melt the methyl methacrylate. When the pressure reached to equal to or higher than the pressure of the reaction vessel 27 (15 MPa), the valves (24, 29) were opened to supply the reducing agent solution in the addition pot 25, tin 2-ethyihexanoate (0.02 mL, 0.05 mmol), into the reaction vessel 27, to thereby initiate polymerization. Forty hours later, methacrylic acid (MA) (20.8 mL, 0.25 mol) was added to the addition pot 25, to which tin 2-ethylhexanoate had been added, and the same procedure to that performed on tin 2-ethylhexanoate was carried out to thereby perform synthesis of a block copolymer of MMA and MA. The reaction was completed 20 hours later, and the valve 28 was released to take out the polymer product in the reaction vessel 27. The polymer product (PMMA-b-MA) was solidified after being taken out. The physical properties of the obtained polymer measured by the aforementioned methods are presented in Table 3.

### Examples 15 to 18

Polymers of Examples 15 to 18 were each obtained in the same manner as in Example 1, provided that the monomer was replaced with an equimolecular amount of methyl acrylate (MA) (Example 15), acrylonitrile (Example 16), dimethylaminoethyl methacrylate (Example 17), or 4-methyl styrene (Example 18), and the molar ratio of the monomer to the initiator was changed to 1,500/1 in Example 17. The physical properties of the obtained polymers measured by the aforementioned methods are presented in Table 4.

### Example 19

### RAFT

Polymerization of methyl methacrylate (MMA) was performed by means of the polymerization reaction device 200 of FIG. 3. As for a radical initiator, 2,2′-azobis(2-methylpropionitrile) (7.7 g, 0.047 mol) was added. Methyl methacrylate (MMA) (50.0 mL, 0.47 mol), from which a polymerization inhibitor had been removed through an alumina column, was added to the reaction vessel 27 in a manner that a molar ratio of the monomer to the initiator was to be 10/1. The pump 22 was operated, and the valves (23, 26) were released to supply carbon dioxide stored in the tank 21 to the reaction vessel 27 without passing through the addition pot 25. The internal temperature of the reaction vessel 27 was set to 80° C., and the reaction vessel 27 was charged with carbon dioxide until the pressure was to be 15 MPa. As a result, methyl methacrylate was brought into contact with carbon dioxide serving as a compressive fluid, to thereby melt the methyl methacrylate. Subsequently, the addition pot 25 was compressed with carbon dioxide. When the pressure reached to equal to or higher than the pressure of the reaction vessel 27 (15 MPa), the valves (24, 29) were opened to supply the RAFT agent in the addition pot 25, 4-cyano-4-[(dodecylsulfanylthiocarbonyl)sulfanyl]pentanoic acid (9.6 g, 0.024 mol), into the reaction vessel 27, to thereby initiate polymerization. The molar ratio of the monomer to the RAFT agent was set to 2,000/1. Forty hours later when the reaction was completed, the valve 28 was released to take out the polymer product in the reaction vessel 27. The polymer product (PMMA) was solidified after being taken out. The weight average molecular weight, and molecular weight distribution of the polymer product (PMMA) and an amount of monomer residues therein determined by the aforementioned methods are presented in Table 4.

### Example 20

### NMP

Polymerization of methyl methacrylate (MMA) was performed by means of the polymerization reaction device 200 of FIG. 3. As for a radical initiator, N-tert-butyl-N-(2-methyl-1-phenylpropyl)-O-(1-phenylethyl) hydroxylamine (0.78 g, 0.0024 mol), and 2,2,5-trimethyl-4-phenyl-3-azahexane-3-nitroxide (26.4 mg, 0.00012 mol) were added to the reaction vessel 27. Methyl methacrylate (MMA) (50.0 mL, 0.47 mol), from which a, polymerization inhibitor had been removed through an alumina column, was added to the reaction vessel 27 in a manner that a molar ratio of the monomer to the initiator was to be 2,000/1. The pump 22 was operated, and the valves (23, 26) were released to supply carbon dioxide stored in the tank 21 to the reaction vessel 27 without passing through the addition pot 25. The internal temperature of the reaction vessel 27 was set to 80° C., and the reaction vessel 27 was charged with carbon dioxide until the pressure was to be 15 MPa. As a result, methyl methacrylate was brought into contact with carbon dioxide serving as a compressive fluid, to thereby melt the methyl methacrylate. Subsequently, the addition pot 25 was compressed with carbon dioxide. When the pressure reached to equal to or higher than the pressure of the reaction vessel 27 (15 MPa), the polymerization was initiated. Forty hours later when the reaction was completed, the valve 28 was released to take out the polymer product in the reaction vessel 27. The polymer product (PMMA) was solidified after being taken out. The weight average molecular weight, and molecular weight distribution of the polymer product (PMMA) and an amount of monomer residues therein determined by the aforementioned methods are presented in Table 4.

### Examples 21 to 24

Polymer products (PMMA, PS, PMMA-b-MA, PMA) of Examples 21 to 24 were obtained in the same manner as in Examples 11, 12, 14, and 15, respectively. Each of the obtained polymer products was pulverized by means of Counter Jet Mill (manufactured by Hosokawa Micron Corporation), to thereby obtain particles having the volume average particle diameter of 6 μm. The physical properties of the obtained particles as the polymer product were measured the aforementioned methods. The results are presented in Table 5.

### Examples 25 to 28

Polymer products (PMMA, PS, PMMA-b-MA, PMA) of Examples 25 to 28 were obtained in the same manner as in Examples 11, 12, 14, and 15, respectively, provided that the molar ratio of the monomer to the initiator was changed to 180/1. Each of the obtained polymer products was pulverized by means of Counter Jet Mill (manufactured by Hosokawa Micron Corporation), to thereby obtain particles having the volume average particle diameter of 6 μm. The physical properties of the obtained particles as the polymer product were measured the aforementioned methods. The results are presented in Table 6.

### Referential Examples 1 to 4

Polymer products (PMMA, PS, PMMA-b-MA, PMA) of Referential Examples 1 to 4 were obtained in the same manner as in Examples 25, 26, 27, and 28, respectively, provided that the reaction time was changed to 10 hours. Each of the obtained polymer products was pulverized by means of Counter Jet Mill (manufactured by Hosokawa Micron Corporation), to thereby obtain particles having the volume average particle diameter of 6 μm. The physical properties of the obtained particles as the polymer product were measured the aforementioned methods. The results are presented in Table 7.

### Examples 29 to 36

Polymer products (PMMA, PS, PMMA-b-MA, PMA) of Examples 29 to 36 were obtained in the same manner as in Examples 21 to 28, respectively. Each of the obtained polymer products was shaped into a film having a thickness of 100 μm at the shaping temperature of 200° C. by means of a general inflation film molding machine.

### Evaluation of Film

The film having a size of 1,000 mm in length, and 1,000 mm in width was visually observed, and whether there was any fish-eye defect was confirmed and evaluated based on the following criteria. The evaluation results of the films are presented in Table 7.

A: There was no fish-eye defect.

B: One to two fish-eye defects were observed.

C: More than three fish-eye defects were observed.

The physical properties of each of the obtained films as the polymer product were measured by the aforementioned methods. The results thereof and the evaluation results of the films are presented in Table 8 or 9.

### Referential Examples 5 to 8

Polymer products (PMMA, PS, PMMA-b-MA, PMA) of Referential Examples 5 to 8 were obtained in the same manner as in Referential Examples 1 to 4, respectively. Each of the obtained polymer products was shaped into a film having a thickness of 100 μm at the shaping temperature of 200° C. by means of a general inflation film molding machine. The physical properties of each of the obtained films as the polymer product were measured by the aforementioned methods. The results are presented in Table 10.

### Examples 37 to 44

Polymer products (PMMA, PS, PMMA-b-MA, PMA) of Examples 37 to 44 were obtained in the same manner as in Example 21 to 28. Using each of the obtained polymer products, an injection molded article having a size of 50 mm in length, 50 mm in width, and 5 mm in depth was formed at the shaping temperature of 200° C. by means of a vertical type injection molding machine with screw (TKP-30-3HS, manufactured by Tabata Industrial Machinery Co., Ltd.).

### Evaluation of Injection Molded Article

One hundred injection molded articles were produced, and evaluation was performed based on formability and appearance.

A: There was no problem in forming ability and appearance.

B: There were slight problems in forming ability and appearance (burrs formed in 1 to 9 samples, and the product was slightly clouded under the visual observation).

C: There were obvious problems in forming ability and appearance (burrs significantly formed in 10 or more samples, and the product was clearly clouded under the visual observation).

The physical properties of each of the obtained injection molded articles as the polymer product were measured by the aforementioned methods. The results thereof and the evaluation results of the injection molded articles are presented in Table 11 or 12.

### Referential Examples 9 to 12

Polymer product (PMMA, PS, PMMA-b-MA, PMA) of Referential Examples 9 to 12 were obtained in the same manner as in Referential Examples 1 to 4, respectively. Injection molded particles were obtained using the obtained polymer products in the manner as described above. The physical properties of each of the obtained injection molded articles as the polymer product were measured by the aforementioned methods. The results thereof and the evaluation results of the injection molded articles are presented in Table 13.

### Examples 45 to 52

Polymer products (PMMA, PS, PMMA-b-MA, PMA) of Examples 45 to 52 were obtained in the same manner as in Examples 21 to 28, respectively. Each of the obtained polymer products was spun by means of a conventional simple melt spinning machine (Capilograph 1D PMD-C, manufactured by Tokyo Seiki Seisaku-sho, Ltd.), and the resultant was drawn by means of a hot-air drawing machine, to thereby obtain a monofilament. The physical properties of each of the obtained monofilaments as the polymer product were measured by the aforementioned methods. The results thereof and evaluation results of the tensile break strength of the fibers are presented in Table 14 or 15.

### Evaluation of Tensile Break Strength

The tensile break strength was measured by means of Strograph RII tensile tester manufactured by Toyo Seiki Seisaku-sho, Ltd., with a test length of 300 mm, and a pulling rate of 300 ram/min. The tensile break strength was evaluated based on the following criteria.

A: 4.0 cN/dtex or greater
B: 2.0 cN/dtex or greater but smaller than 4.0 cN/dtex
C: smaller than 2.0 cN/dtex

### Referential Examples 13 to 16

Polymer products (PMMA, PS, PMMA-b-MA, PMA) of Referential Examples 13 to 16 were obtained in the same manner as in Referential Examples 1 to 4, respectively. Using each of the obtained polymer products, a monofilament was obtained in the manner described above. The physical properties of the obtained monofilament as the polymer product, and the tensile break strength of the fibers were measured by the aforementioned methods. The results are presented in Table 16.

### Examples 53, 54

Polymer products of Examples 53 and 54 were each obtained in the same manner as in Example 19, provided that the RAFT agent was replaced with an equimolecular amount of cyanomethyl methyl(phenyl)carbamodithioate, and the monomer was replaced with an equimolecular amount of vinyl acetate (Example 53) or acryl amide (Example 54). The physical properties of the obtained polymers measured by the aforementioned methods are presented in Table 17.

### Example 55

A polymer product of Example 55 was obtained in the same manner as in Example 19, provided that RAFT agent was replaced with an equimolecular amount of 2-phenyl-2-propyl benzodithioate, and the monomer was replaced with an equimolecular amount of chloroprene (Example 55). The physical properties of the obtained polymer measured by the aforementioned methods are presented in Table 17.

### Examples 56 to 58

Polymer products of Examples 56 to 58 were obtained in the same manner as in Example 53, 54, and 55, respectively. Each of the obtained polymer products was pulverized by means of Counter Jet Mill (manufactured by Hosokawa Micron Corporation), to thereby obtain particles having the volume average particle diameter of 6 The physical properties of the obtained particles as the polymer product were measured by the aforementioned methods. The results are presented in Table 18.

### Examples 59 to 61

Polymer products of Examples 59 to 61 were obtained in the same manner as in Examples 53, 54, and 55, respectively, provided that the molar ratio of the monomer to the RAFT agent was changed to 180/1. Each of the obtained polymer products was pulverized by means of Counter Jet Mill (manufactured by Hosokawa Micron Corporation), to thereby obtain particles having the volume average particle diameter of 6 μm. The physical properties of the obtained particles as the polymer product were measured by the aforementioned methods. The results are presented in Table 19.

### Referential Examples 17 to 19

Polymer products of Referential Examples 17 to 19 were obtained in the same manner as in Examples 59 to 61, respectively, provided that the reaction time was changed to 10 hours. Each of the obtained polymer products was pulverized by means of Counter Jet Mill (manufactured by Hosokawa Micron Corporation), to thereby obtain particles having the volume average particle diameter of 6 μm. The physical properties of the obtained particles as the polymer product were measured by the aforementioned methods. The results are presented in Table 20.

### Examples 62 to 67

Polymer products of Examples 62 to 67 were obtained in the same manner as in Examples 56 to 61, respectively. Each of the obtained polymer products was shaped into a film having a thickness of 100 μm at the shaping temperature of 200° C. by means of a general inflation film molding machine. The physical properties of the obtained films as the polymer product and evaluation of the films were measured or performed by the aforementioned methods. The results are presented in Table 21 or 22.

### Referential Examples 20 to 22

Polymer products of Referential Examples 20 to 22 were obtained in the same manner as in Referential Examples 17 to 19, respectively. Each of the obtained polymer products was shaped into a film having a thickness of 100 μm at the shaping temperature of 200° C. by means of a general inflation film molding machine. The physical properties of the obtained films as the polymer product and evaluation of the films were measured or performed by the aforementioned methods. The results are presented in Table 23.

### Examples 68 to 73

Polymer products of Examples 68 to 73 were obtained in the same manner as in Examples 56 to 61, respectively. Using each of the obtained polymer products, an injection molded article was obtained by the aforementioned method. The results of the physical properties of the obtained injection molded articles as the polymer product measured by the aforementioned methods, and the evaluation results thereof are presented in Table 24 or 25.

### Referential Examples 23 to 25

Polymer products of Referential Examples 23 to 25 were obtained in the same manner as in Referential Examples 17 to 20, respectively. Using each of the obtained polymer products, an injection molded article was obtained by the aforementioned method. The results of the physical properties of the obtained injection molded articles as the polymer product measured by the aforementioned methods, and the evaluation results thereof are presented in Table 26.

### Examples 74 to 79

Polymer products of Examples 74 to 79 were obtained in the same manner as in Examples 56 to 61, respectively. A monofilament was obtained from each of the obtained polymer product by the aforementioned method. The physical properties of the obtained monofilaments as the polymer product and the tensile break strength of the fibers are measured by the aforementioned methods. The results are presented in Table 27 or 28.

### Referential Examples 26 to 28

Polymer product of Referential Examples 26 to 28 were obtained in the same manner as in Referential Examples 17 to 19, respectively. A monofilament was obtained from each of the obtained polymer product by the aforementioned method. The physical properties of the obtained monofilaments as the polymer product and the tensile break strength of the fibers are measured by the aforementioned methods. The results are presented in Table 29.

TABLE 1

| | Ex. 1 | Ex. 2 | Ex. 3 | Ex. 4 | Ex. 5 |
|---|---|---|---|---|---|
| Monomer | MMA | MMA | MMA | MMA | MMA |
| Initiator | Ethyl | Bi- | Tri- | Tetra- | Hexa- |
| | 2-bromo- | functional | functional | functional | functional |
| | isobutyrate | initiator | initiator | initiator | initiator |
| Catalyst | Cupric | Cupric | Cupric | Cupric | Cupric |
| | chloride | chloride | chloride | chloride | chloride |
| Ligand | Tris[2- | Tris[2- | Tris[2- | Tris[2- | Tris[2- |
| | (dimethylamino) | (dimethylamino) | (dimethylamino) | (dimethylamino) | (dimethylamino) |
| | ethyl]amine | ethyl]amine | ethyl]amino | ethyl]amine | ethyl]amine |
| Reaction | 80 | 80 | 80 | 80 | 80 |
| temperature | | | | | |
| (° C.) | | | | | |
| Reaction | 15 | 15 | 15 | 15 | 15 |
| pressure | | | | | |
| (MPa) | | | | | |
| Reaction | 40 | 40 | 40 | 40 | 40 |
| time (h) | | | | | |
| Monomer/ | 2,000 | 2,000 | 2,000 | 2,000 | 2,000 |
| initiator | | | | | |
| Mn | 198,500 | 198,700 | 198,800 | 199,000 | 198,600 |
| Monomer | 0.9 | 0.8 | 0.7 | 0.6 | 0.8 |
| residues | | | | | |
| (mass %) | | | | | |
| Mn/Mw | 1.09 | 1.14 | 1.12 | 1.15 | 1.12 |

TABLE 2

| | Ex. 6 | Ex. 7 | Ex. 8 | Ex. 9 |
|---|---|---|---|---|
| Monomer | MMA | MMA | MMA | MMA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | Tris[2- | Tris[2- | Tris[2- | Tris[2- |
| | (dimethylamino) | (dimethylamino) | (dimethylamino) | (dimethylamino) |
| | ethyl]amine | ethyl]amine | ethyl]amine | ethyl]amine |
| Reaction | 100 | 120 | 80 | 80 |
| temperature | | | | |
| (° C.) | | | | |
| Reaction | 15 | 15 | 10 | 25 |
| pressure | | | | |
| (MPa) | | | | |
| Reaction | 40 | 40 | 40 | 40 |
| time (h) | | | | |
| Monomer/ | 2,000 | 2,000 | 2,000 | 2,000 |
| initiator | | | | |
| Mn | 199,000 | 199,500 | 198,700 | 198,600 |
| Monomer | 0.6 | 0.4 | 0.8 | 0.8 |
| residues | | | | |
| (mass %) | | | | |
| Mn/Mw | 1.13 | 1.10 | 1.12 | 1.08 |

TABLE 3

| | Ex. 10 | Ex. 11 | Ex. 12 | Ex. 13 | Ex. 14 |
|---|---|---|---|---|---|
| Monomer | MMA | MMA | Styrene | MMA/MA | MMA + MA |
| Initiator | Ethyl | Ethyl | Ethyl | Ethyl | Ethyl |
| | 2-bromo- | 2-bromo- | 2-bromo- | 2-bromo- | 2-bromo- |
| | isobutyrate | isobutyrate | isobutyrate | isobutyrate | isobutyrate |
| Catalyst | Cupric | Cupric | Cupric | Cupric | Cupric |
| | chloride | chloride | chloride | chloride | chloride |
| Ligand | 4,4′-dimethyl- | N-butyl-2- | Tris[2- | Tris[2- | 4,4′-dimethyl- |
| | 2,2′-dipyridyl | pyridyl- | (dimethylamino) | (dimethylamino) | 2,2′-dipyridyl |
| | | methanimine | ethyl]amine | ethyl]amine | |
| Reaction | 80 | 80 | 80 | 80 | 80 |
| temp. (° C.) | | | | | |
| Reaction | 15 | 15 | 15 | 15 | 15 |
| pressure | | | | | |
| (MPa) | | | | | |
| Reaction | 40 | 40 | 40 | 40 | 40 + 20 |
| time (h) | | | | | |
| Monomer/ | 2,000 | 2,000 | 2,000 | 2,000 | 1,100 |
| initiator | | | | | |
| Mn | 199,000 | 198,700 | 206,500 | 196,000 | 203,000 |
| Monomer | 0.6 | 0.8 | 0.9 | 0.7 | 0.9 |
| residues | | | | | |
| (mass %) | | | | | |
| Mn/Mw | 1.08 | 1.08 | 1.10 | 1.08 | 1.12 |

TABLE 4

| | Ex. 15 | Ex. 16 | Ex. 17 | Ex. 18 | Ex. 19 | Ex. 20 |
|---|---|---|---|---|---|---|
| Monomer | MA | Acrylonitrile | Dimethyl- | 4-methyl | MMA | MMA |
| | | | aminoethyl | styrene | | |
| | | | methacrylate | | | |
| Initiator | Ethyl | Ethyl | Ethyl | Ethyl | AIBN | N-tert-butyl-N- |
| | 2-bromo- | 2-bromo- | 2-bromo- | 2-bromo- | | (2-methyl-1- |
| | isobutyrate | isobutyrate | isobutyrate | isobutyrate | | phenylpropyl)-O- |
| | | | | | | (1-phenylethyl)hydro- |
| | | | | | | oxylamine |
| Catalyst, | Cupric | Cupric | Cupric | Cupric | 4-cyano- | 2,2,5-trimethyl- |
| RAFT | chloride | chloride | chloride | chloride | 4[(dodecylsulfanyl- | 4-phenyl-3- |
| agent, or | | | | | thiocarbonyl)sulfanyl] | azahexane-3- |
| nitroxide | | | | | pentanoic acid | nitroxide |
| compound | | | | | | |
| Ligand | Tris[2-(dimethyl- | Tris[2-(dimethyl- | Tris[2-(dimethyl- | Tris[2-(dimethyl- | — | — |
| | amino)ethyl]amine | amino)ethyl]amine | amino)ethyl]amine | amino)ethyl]amine | | |
| Reaction | 80 | 80 | 80 | 80 | 80 | 80 |
| temp. (° C.) | | | | | | |
| Reaction | 15 | 15 | 15 | 15 | 15 | 15 |
| pressure | | | | | | |
| (MPa) | | | | | | |
| Reaction | 40 | 40 | 40 | 40 | 40 | 40 |
| time (h) | | | | | | |
| Monomer/ | 2,000 | 2,000 | 1,500 | 2,000 | 10 | 2,000 |
| initiator | | | | | | |
| Mn | 170,500 | 105,200 | 235,000 | 234,000 | 198,500 | 200,000 |
| Monomer | 0.9 | 0.9 | 0.3 | 1.0 | 0.8 | 0.1 |
| residues | | | | | | |
| (mass %) | | | | | | |
| Mn/Mw | 1.10 | 1.15 | 1.17 | 1.08 | 1.20 | 1.16 |

TABLE 5

| | Ex. 21 | Ex. 22 | Ex. 23 | Ex. 24 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | N-butyl-2- | Tris[2- | 4,4′-dimethyl- | Tris[2- |
| | pyridylmethanimine | (dimethylamino) | 2,2′-dipyridyl | (dimethylamino) |
| | | ethyl]amine | | ethyl]amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 40 | 40 | 40 + 20 | 40 |
| time (h) | | | | |
| Monomer/ | 2,000 | 2,000 | 1,100 | 2,000 |
| initiator | | | | |
| Mn | 198,700 | 206,500 | 203,000 | 170,500 |
| Monomer | 0.8 | 0.9 | 0.9 | 0.9 |
| residues | | | | |
| (mass %) | | | | |
| Mn/Mw | 1.08 | 1.10 | 1.12 | 1.10 |

TABLE 6

| | Ex. 25 | Ex. 26 | Ex. 27 | Ex. 28 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | N-butyl-2- | Tris[2- | 4,4′-dimethyl- | Tris[2- |
| | pyridylmethanimine | (dimethylamino) | 2,2′-dipyridyl | (dimethylamino) |
| | | ethyl]amine | | ethyl]amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 40 | 40 | 40 + 20 | 40 |
| time (h) | | | | |
| Monomer/ | 180 | 180 | 180 | 180 |
| initiator | | | | |
| Mn | 18,000 | 18,600 | 17,600 | 15,400 |
| Monomer | 0.1 | 0.8 | 0.9 | 0.6 |
| residues | | | | |
| (mass %) | | | | |
| Mn/Mw | 1.15 | 1.18 | 1.12 | 1.08 |

TABLE 7

| | Ref. Ex. 1 | Ref. Ex. 2 | Ref. Ex. 3 | Ref. Ex. 4 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | Tris[2- | Tris[2- | 4,4′-dimethyl- | Tris[2- |
| | (dimethylamino) | (dimethylamino) | 2,2′-dipyridyl | (dimethylamino) |
| | ethyl]amine | ethyl]amine | | ethyl]amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 10 | 10 | 10 + 10 | 10 |
| time (h) | | | | |
| Monomer/ | 180 | 180 | 180 | 180 |
| initiator | | | | |
| Mn | 14,500 | 14,600 | 14,000 | 14,400 |
| Monomer | 19.5 | 22.1 | 21.2 | 7.0 |
| residues | | | | |
| (mass %) | | | | |
| Mn/Mw | 1.80 | 2.10 | 2.00 | 2.09 |

TABLE 8

| | Ex. 29 | Ex. 30 | Ex. 31 | Ex. 32 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | N-butyl-2- | Tris[2- | 4,4′-dimethyl- | Tris[2- |
| | pyridylmethanimine | (dimethylamino) | 2,2′-dipyridyl | (dimethylamino) |
| | | ethyl]amine | | ethyl]amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 40 | 40 | 40 + 20 | 40 |
| time (h) | | | | |
| Monomer/ | 2,000 | 2,000 | 1,100 | 2,000 |
| initiator | | | | |
| Mn | 198,700 | 206,500 | 203,000 | 170,500 |
| Monomer | 0.8 | 0.9 | 0.9 | 0.9 |
| residues | | | | |
| (mass %) | | | | |
| Mn/Mw | 1.08 | 1.10 | 1.12 | 1.10 |
| Film | A | A | A | A |
| fish-eye | | | | |

TABLE 9

| | Ex. 33 | Ex. 34 | Ex. 35 | Ex. 36 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | N-butyl-2- | Tris[2- | 4,4′-dimethyl- | Tris[2- |
| | pyridylmethanimine | (dimethylamino) | 2,2′-dipyridyl | (dimethylamino) |
| | | ethyl]amine | | ethyl]amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 40 | 40 | 40 + 20 | 40 |
| time (h) | | | | |
| Monomer/ | 180 | 180 | 180 | 180 |
| initiator | | | | |
| Mn | 18,000 | 18,600 | 17,600 | 15,400 |
| Monomer | 0.1 | 0.8 | 0.9 | 0.6 |
| residues | | | | |
| (mass %) | | | | |
| Mn/Mw | 1.15 | 1.18 | 1.12 | 1.08 |
| Film | B | B | B | B |
| fish-eye | | | | |

TABLE 10

| | Ref. Ex. 5 | Ref. Ex. 6 | Ref. Ex. 7 | Ref. Ex. 8 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | Tris[2- | Tris[2- | 4,4′-dimethyl- | Tris[2- |
| | (dimethylamino) | (dimethylamino) | 2,2′-dipyridyl | (dimethylamino) |
| | ethyl]amine | ethyl]amine | | ethyl]amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 10 | 10 | 10 + 10 | 10 |
| time (h) | | | | |
| Monomer/ | 180 | 180 | 180 | 180 |
| initiator | | | | |
| Mn | 14,500 | 14,600 | 14,000 | 14,400 |
| Monomer | 19.5 | 22.1 | 21.2 | 7.0 |
| residues | | | | |
| (mass %) | | | | |
| Mn/Mw | 1.80 | 2.10 | 2.00 | 2.09 |
| Film | C | C | C | C |
| fish-eye | | | | |

TABLE 11

| | Ex. 37 | Ex. 38 | Ex. 39 | Ex. 40 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | N-butyl-2- | Tris[2- | 4,4′-dimethyl- | Tris[2- |
| | pyridylmethanimine | (dimethylamino) | 2,2′-dipyridyl | (dimethylamino) |
| | | ethyl]amine | | ethyl]amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 40 | 40 | 40 + 20 | 40 |
| time (h) | | | | |
| Monomer/ | 2,000 | 2,000 | 1,100 | 2,000 |
| initiator | | | | |
| Mn | 198,700 | 206,500 | 203,000 | 170,500 |
| Monomer | 0.8 | 0.9 | 0.9 | 0.9 |
| residues | | | | |
| (mass %) | | | | |
| Mn/Mw | 1.08 | 1.10 | 1.12 | 1.10 |
| Molded | A | A | A | A |
| article | | | | |

TABLE 12

| | Ex. 41 | Ex. 42 | Ex. 43 | Ex. 44 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | N-butyl-2- | Tris[2- | 4,4′-dimethyl- | Tris[2- |
| | pyridylmethanimine | (dimethylamino) | 2,2′-dipyridyl | (dimethylamino) |
| | | ethyl]amine | | ethyl]amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 40 | 40 | 40 + 20 | 40 |
| time (h) | | | | |
| Monomer/ | 180 | 180 | 180 | 180 |
| initiator | | | | |
| Mn | 18,000 | 18,600 | 17,600 | 15,400 |
| Monomer | 0.1 | 0.8 | 0.9 | 0.6 |
| residues | | | | |
| (mass %) | | | | |
| Mn/Mw | 1.15 | 1.18 | 1.12 | 1.08 |
| Molded | B | B | B | B |
| article | | | | |

TABLE 13

| | Ref. Ex. 9 | Ref. Ex. 10 | Ref. Ex. 11 | Ref. Ex. 12 |
|---|---|---|---|---|
| Monomer | MMA | Styrene | MA | MMA + MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | Tris[2- | Tris[2- | Tris[2- | 4,4′-dimethyl- |
| | (dimethylamino) | (dimethylamino) | (dimethylamino) | 2,2′-dipyridyl |
| | ethyl]amine | ethyl]amine | ethyl]amine | |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 10 | 10 | 10 + 10 | 10 |
| time (h) | | | | |
| Monomer/ | 180 | 180 | 180 | 180 |
| initiator | | | | |
| Mn | 14,500 | 14,600 | 14,000 | 14,400 |
| Monomer | 19.5 | 22.1 | 21.2 | 7.0 |
| residues | | | | |
| (mass %) | | | | |
| Mn/Mw | 1.80 | 2.10 | 2.09 | 2.00 |
| Molded | C | C | C | C |
| article | | | | |

TABLE 14

| | Ex. 45 | Ex. 46 | Ex. 47 | Ex. 48 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | N-butyl-2- | Tris[2- | 4,4′-dimethyl- | Tris[2- |
| | pyridylmethanimine | (dimethylamino) | 2,2′-dipyridyl | (dimethylamino) |
| | | ethyl]amine | | ethyl]amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 40 | 40 | 40 + 20 | 40 |
| time (h) | | | | |
| Monomer/ | 2,000 | 2,000 | 1,100 | 2,000 |
| initiator | | | | |
| Mn | 198,700 | 206,500 | 203,000 | 170,500 |
| Monomer | 0.8 | 0.9 | 0.9 | 0.9 |
| residues | | | | |
| (mass %) | | | | |
| Mn/Mw | 1.08 | 1.10 | 1.12 | 1.10 |
| Fiber | A | A | A | A |
| tensile | | | | |
| break | | | | |
| strength | | | | |

TABLE 15

| | Ex. 49 | Ex. 50 | Ex. 51 | Ex. 52 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | N-butyl-2- | Tris[2- | 4,4′- | Tris[2- |
| | pyridyl- | (dimethyl- | dimethyl- | (dimethyl- |
| | methanimine | amino) | 2,2′- | amino) |
| | | ethyl] | dipyridyl | ethyl] |
| | | amine | | amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 40 | 40 | 40 + 20 | 40 |
| time (h) | | | | |
| Monomer/ | 180 | 180 | 180 | 180 |
| initiator | | | | |
| Mn | 18,000 | 18,600 | 17,600 | 15,400 |
| Monomer | 0.1 | 0.8 | 0.9 | 0.6 |
| residues | | | | |
| (mass %) | | | | |
| Mn/Mw | 1.15 | 1.18 | 1.12 | 1.08 |
| Fiber | B | B | B | B |
| tensile | | | | |
| break | | | | |
| strength | | | | |

TABLE 16

| | Ref. Ex. 13 | Ref. Ex. 14 | Ref. Ex. 15 | Ref. Ex. 16 |
|---|---|---|---|---|
| Monomer | MMA | Styrene | MMA + MA | MA |
| Initiator | Ethyl | Ethyl | Ethyl | Ethyl |
| | 2-bromo- | 2-bromo- | 2-bromo- | 2-bromo- |
| | isobutyrate | isobutyrate | isobutyrate | isobutyrate |
| Catalyst | Cupric | Cupric | Cupric | Cupric |
| | chloride | chloride | chloride | chloride |
| Ligand | Tris[2- | Tris[2- | 4,4′- | Tris[2- |
| | (dimethyl- | (dimethyl- | dimethyl- | (dimethyl- |
| | amino) | amino) | 2,2′- | amino) |
| | ethyl] | ethyl] | dipyridyl | ethyl] |
| | amine | amine | | amine |
| Reaction | 80 | 80 | 80 | 80 |
| temperature | | | | |
| (° C.) | | | | |
| Reaction | 15 | 15 | 15 | 15 |
| pressure | | | | |
| (MPa) | | | | |
| Reaction | 10 | 10 | 10 + 10 | 10 |
| time (h) | | | | |
| Monomer/ | 180 | 180 | 180 | 180 |
| initiator | | | | |
| Mn | 14,500 | 14,600 | 14,000 | 14,400 |
| Monomer | 19.5 | 22.1 | 21.2 | 7.0 |
| residues | | | | |
| (mass %) | | | | |
| Mn/Mw | 1.80 | 2.10 | 2.00 | 2.09 |
| Fiber | C | C | C | C |
| tensile | | | | |
| break | | | | |
| strength | | | | |

TABLE 17

| | Ex. 53 | Ex. 54 | Ex. 55 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 40 | 40 | 40 |
| time (h) | | | |
| Monomer/ | 2,000 | 2,000 | 2,000 |
| RAFT agent | | | |
| Mn | 171,000 | 141,500 | 175,500 |
| Monomer | 0.7 | 0.5 | 0.8 |
| residues | | | |
| (mass %) | | | |
| Mn/Mw | 1.10 | 1.08 | 1.15 |

TABLE 18

| | Ex. 56 | Ex. 57 | Ex. 58 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 40 | 40 | 40 |
| time (h) | | | |
| Monomer/ | 2,000 | 2,000 | 2,000 |
| RAFT agent | | | |
| Mn | 171,000 | 141,500 | 175,500 |
| Monomer | 0.7 | 0.5 | 0.8 |
| residues | | | |
| (mass %) | | | |
| Mn/Mw | 1.10 | 1.08 | 1.15 |

TABLE 19

| | Ex. 59 | Ex. 60 | Ex. 61 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 40 | 40 | 40 |
| time (h) | | | |
| Monomer/ | 180 | 180 | 180 |
| RAFT agent | | | |
| Mn | 15,450 | 12,700 | 15,800 |
| Monomer | 0.3 | 0.7 | 0.8 |
| residues | | | |
| (mass %) | | | |
| Mn/Mw | 1.05 | 1.07 | 1.15 |

TABLE 20

| | Ref. Ex. 17 | Ref. Ex. 18 | Ref. Ex. 19 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 10 | 10 | 10 |
| time (h) | | | |
| Monomer/ | 180 | 180 | 180 |
| RAFT agent | | | |
| Mn | 13,300 | 11,000 | 13,900 |
| Monomer | 14.2 | 14.0 | 12.7 |
| residues | | | |
| (mass %) | | | |
| Mn/Mw | 1.90 | 2.00 | 1.97 |

TABLE 21

| | Ex. 62 | Ex. 63 | Ex. 64 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 40 | 40 | 40 |
| time (h) | | | |
| Monomer/ | 2,000 | 2,000 | 2,000 |
| RAFT agent | | | |
| Mn | 171,000 | 141,500 | 175,500 |
| Monomer | 0.7 | 0.5 | 0.8 |
| residues | | | |
| (mass %) | | | |
| Mn/Mw | 1.10 | 1.08 | 1.15 |
| Film | A | A | A |
| fish-eye | | | |

TABLE 22

| | Ex. 65 | Ex. 66 | Ex. 67 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 40 | 40 | 40 |
| time (h) | | | |
| Monomer/ | 180 | 180 | 180 |
| RAFT agent | | | |
| Mn | 15,450 | 12,700 | 15,800 |
| Monomer | 0.3 | 0.7 | 0.8 |
| residues | | | |
| (mass %) | | | |
| Mn/Mw | 1.05 | 1.07 | 1.15 |
| Film | B | B | B |
| fish-eye | | | |

TABLE 23

| | Ref. Ex. 20 | Ref. Ex. 21 | Ref. Ex. 22 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 10 | 10 | 10 |
| time (h) | | | |
| Monomer/ | 180 | 180 | 180 |
| RAFT agent | | | |
| Mn | 13,300 | 11,000 | 13,900 |
| Monomer | 14.2 | 14.0 | 12.7 |
| residues | | | |
| (mass %) | | | |
| Mn/Mw | 1.90 | 2.00 | 1.97 |
| Film | C | C | C |
| fish-eye | | | |

TABLE 24

| | Ex. 68 | Ex. 69 | Ex. 70 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 40 | 40 | 40 |
| time (h) | | | |
| Monomer/ | 2,000 | 2,000 | 2,000 |
| RAFT agent | | | |
| Mn | 171,000 | 141,500 | 175,500 |
| Monomer | 0.7 | 0.5 | 0.8 |
| residues | | | |
| (mass %) | | | |
| Mn/Mw | 1.10 | 1.08 | 1.15 |
| Molded | A | A | A |
| article | | | |

TABLE 25

| | Ex. 71 | Ex. 72 | Ex. 73 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 40 | 40 | 40 |
| time (h) | | | |
| Monomer/ | 180 | 180 | 180 |
| RAFT agent | | | |
| Mn | 15,450 | 12,700 | 15,800 |
| Monomer | 0.3 | 0.7 | 0.8 |
| residues | | | |
| (mass %) | | | |
| Mn/Mw | 1.05 | 1.07 | 1.15 |
| Molded | B | B | B |
| article | | | |

TABLE 26

| | Ref. Ex. 23 | Ref. Ex. 24 | Ref. Ex. 25 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 10 | 10 | 10 |
| time (h) | | | |
| Monomer/ | 180 | 180 | 180 |
| RAFT agent | | | |
| Mn | 13,300 | 11,000 | 13,900 |
| Monomer | 14.2 | 14.0 | 12.7 |
| residues | | | |
| (mass %) | | | |
| Mn/Mw | 1.90 | 2.00 | 1.97 |
| Molded | C | C | C |
| article | | | |

TABLE 27

| | Ex. 74 | Ex. 75 | Ex. 76 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 40 | 40 | 40 |
| time (h) | | | |
| Monomer/ | 2,000 | 2,000 | 2,000 |
| RAFT agent | | | |
| Mn | 171,000 | 141,500 | 175,500 |
| Monomer | 0.7 | 0.5 | 0.8 |
| residues | | | |
| (mass %) | | | |
| Mn/Mw | 1.10 | 1.08 | 1.15 |
| Fiber | A | A | A |
| tensile | | | |
| break | | | |
| strength | | | |

TABLE 28

| | Ex. 77 | Ex. 78 | Ex. 79 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 40 | 40 | 40 |
| time (h) | | | |
| Monomer/ | 180 | 180 | 180 |
| RAFT agent | | | |
| Mn | 15,450 | 12,700 | 15,800 |
| Monomer | 0.3 | 0.7 | 0.8 |
| residues | | | |
| (mass %) | | | |
| Mn/Mw | 1.05 | 1.07 | 1.15 |
| Fiber | B | B | B |
| tensile | | | |
| break | | | |
| strength | | | |

TABLE 29

| | Ref. Ex. 26 | Ref. Ex. 27 | Ref. Ex. 28 |
|---|---|---|---|
| Monomer | Vinyl acetate | Acryl amide | Chloroprene |
| Initiator | AIBN | AIBN | AIBN |
| RAFT agent | Cyanomethyl | Cyanomethyl | 2-phenyl-2-propyl |
| | methyl(phenyl) | methyl(phenyl) | benzodithioate |
| | carbamodithioate | carbamodithioate | |
| Reaction | 80 | 80 | 80 |
| temperature | | | |
| (° C.) | | | |
| Reaction | 15 | 15 | 15 |
| pressure | | | |
| (MPa) | | | |
| Reaction | 10 | 10 | 10 |
| time (h) | | | |
| Monomer/ | 180 | 180 | 180 |
| RAFT agent | | | |
| Mn | 13,300 | 11,000 | 13,900 |
| Monomer | 14.2 | 14.0 | 12.7 |
| residues | | | |
| (mass %) | | | |
| Mn/Mw | 1.90 | 2.00 | 1.97 |
| Fiber | C | C | C |
| tensile | | | |
| break | | | |
| strength | | | |

### REFERENCE SIGNS LIST

1, 3, 5, 7, 11: tank
2, 4: metering feeder
6, 8, 12, 14: metering pump
9: blending device
10: feeding pump
13: reaction vessel
15: extrusion cap
21: tank
22: metering pump
25: addition pot
27: reaction vessel
28: valve
30: piping
100: polymerization reaction device
200: polymerization reaction device

1. A method for producing a polymer, comprising:
bringing a monomer containing a vinyl bond into contact with a compressive fluid and melting or dissolving the monomer containing a vinyl bond, followed by carrying out addition polymerization of the monomer containing a vinyl bond in the presence of an initiator.

2. The method according to claim 1, wherein the compressive fluid contains carbon dioxide, ether, or hydrocarbon.

3. The method according to claim 1, wherein a polymerization rate of the monomer containing a vinyl bond is 98% by mass or greater, and the monomer containing a vinyl bond is melted or dissolved without using an organic solvent.

4. The method according to claim 1, wherein the monomer containing a vinyl bond is an acryl-based monomer.

5. The method according to claim 1, wherein the monomer containing a vinyl bond is a styrene-based monomer.

6. The method according to claim 1, wherein the monomer containing a vinyl bond is an acrylamide-based monomer.

7. The method according to claim 1, wherein the monomer containing a vinyl bond is a diene-based monomer.

8. A polymer product, comprising:
an organic solvent in an amount of less than 5 ppm; and
monomer residues in an amount of 2% by mass or less, and
wherein a number average molecular weight of the polymer product is 15,000 or greater, and a molecular weight distribution (Mw/Mn) represented by a ratio of a weight average molecular weight of the polymer product to the number average molecular weight is 1.2 or less.

9. The polymer product according to claim 8, wherein the weight average molecular weight of the polymer product is 5,000 or greater.

10. The polymer product according to claim 8, wherein the polymer product is a copolymer containing two or more polymer segments.

11. The polymer product according to claim 8, wherein the polymer product is a copolymer having a multibranched structure.

12. Particles, each comprising:
the polymer product according to claim 8.

13. A film comprising:
the polymer product according to claim 8.

14. A molded article comprising:
the polymer product according to claim 8.

15. Fibers, each comprising:
the polymer product according to claim 8.
